(19) United States
(12) Patent Application Publication
(10) Pub. No.: US 2006/0243230 A1
(43) Pub. Date: Nov. 2, 2006

(54) Two-stroke engine

(76) Inventors: Nagesh S. Mavinahally, Anderson, SC (US); David R. Brower, Townville, SC (US)

Correspondence Address: BRINKS HOFER GILSON & LIONE, P.O. BOX 10395, CHICAGO, IL, 60610, US

(21) Appl. No.: 11/385,977

(22) Filed: Mar. 20, 2006

Related U.S. Application Data
(63) Continuation-in-part of application No. 11/351,318, filed on Feb. 9, 2006.
(60) Provisional application No. 60/665,657, filed on Mar. 23, 2005.

(51) Int. Cl. F02B 33/04; F02B 25/00

(52) U.S. Cl. 123/73 B; 123/73 PP

(57) ABSTRACT

A two-stroke internal combustion engine is provided with a transfer passage in gaseous communication with the combustion chamber. The intake system supplies air to the transfer passage and/or the crankcase. A fuel injector may be used to supply fuel to the air supplied to the crankcase or the transfer passage.

This application claims priority to U.S. Provisional Application No. 60/665,657, filed Mar. 23, 2005, and is a continuation-in-part of U.S. patent application Ser. No. 11/351,318, filed Feb. 9, 2006, both of which are hereby incorporated by reference herein.

### BACKGROUND

The present invention relates to two-stroke engines.

Conventional two-stroke engines suffer from high hydrocarbon emissions and poor fuel efficiency because they use a fresh fuel-air mixture to scavenge the combustion chamber. It is known in the prior art to reduce the system-caused scavenging losses in two-stroke engines by advancing fuel-free scavenging air ahead of a fuel-air mixture. This reduces the fuel that is lost due to short circuiting fresh fuel-air mixture in the combustion chamber with the exhaust port.

Scavenging two stroke engines with stratified air-heads have been developed to address this problem. One example of such an engine is described in U.S. Patent Application No. 2004/0040522, filed May 28, 2003, and entitled Two Stroke Engine With Rotatably Modulated Gas Passage. In this design, the stratified air-head two-stroke engine inducts scavenging air from the top of transfer passages through reed valves or piston porting. However, this design also requires a special carburetor requiring two valves, one for air and the other for the air-fuel mixture.

Accordingly, it is apparent to the inventors that an improved two-stroke engine is needed. As described more fully below, the inventors have devised a number of improvements that may be useful in a variety of two-stroke engines.

### BRIEF SUMMARY

Embodiments of the present invention provide a two-stroke engine with a transfer passage in gaseous communication with the combustion chamber. The transfer passage may also be in gaseous communication with the crankcase. The intake system supplies air to the transfer passage and/or to the crankcase during at least part of the piston cycle. A fuel injector may be used to supply fuel to the air. A low pressure pump may also be provided to pressurize the fuel supplied to the fuel injector. Additional details are described below.

### BRIEF DESCRIPTION OF THE DRAWINGS

The invention may be more fully understood by reading the following description in conjunction with the drawings, in which:

FIG. 1 shows a front cross section view of one embodiment of a two-stroke engine of the present invention.

FIG. 1A shows a front cross section view of another embodiment of a two-stroke engine of the present invention where the fuel injector is in the cylinder wall.

FIG. 2 shows a top cross section view of the two-stroke engine of FIG. 1.

FIG. 3 shows a timing diagram for a two-stroke engine having a reed valve controlled intake system.

FIG. 4 shows a front cross section view of another embodiment of a two-stroke engine of the present invention.

FIG. 5 shows a top cross section view of the two-stroke engine of FIG. 4.

FIG. 6 shows a front cross section view of another embodiment of a two-stroke engine of the present invention near BDC.

FIG. 7 shows a front cross section view of another embodiment of a two-stroke engine of the present invention near TDC.

FIG. 8 shows a top cross section view of the two-stroke engine of FIGS. 6-7.

FIG. 9 shows a timing diagram for a two-stroke engine having a piston port and rotary valve controlled intake system.

FIG. 9A shows a timing diagram for a two-stroke engine having a piston port and rotary valve controlled intake system where the fuel injector is located down stream of the reed valves or when fuel is injected directly into the transfer passage or near transfer ports.

FIG. 10 shows a front cross section view of another embodiment of a two-stroke engine of the present invention near BDC.

FIG. 11 shows a front cross section view of another embodiment of a two-stroke engine of the present invention near TDC.

FIG. 12 shows a top cross section view of a two-stroke engine of FIGS. 10-11.

FIG. 13 shows a front cross section view of another embodiment of a two-stroke engine of the present invention near BDC.

FIG. 14 shows a front cross section view of another embodiment of a two-stroke engine of the present invention near TDC.

FIG. 15 shows a top cross section view of the two-stroke engine of FIGS. 13-14.

FIG. 16 shows a front cross section view of an embodiment of a two-stroke engine of the present invention having piston ports near BDC.

FIG. 16A shows a front cross section view of another embodiment of a two-stroke engine of the present invention having piston ports near BDC where the fuel injector is in the cylinder wall.

FIG. 17 shows a front cross section view of an embodiment of a two-stroke engine of the present invention having piston ports near TDC.

FIG. 17A shows a front cross section view of an embodiment of a two-stroke engine of the present invention having piston ports near TDC where the fuel injector is in the cylinder wall.

FIG. 18 shows a front cross section view of another embodiment of a two-stroke engine of the present invention near BDC.

FIG. 19 shows a front cross section view of another embodiment of a two-stroke engine of the present invention near TDC.

FIG. 20 shows a top cross section view of the two-stroke engine of FIGS. 18-19.

FIG. 21 shows a front cross section view of an embodiment of a two-stroke engine of the present invention having piston ports near BDC.

FIG. 22 shows a front cross section view of an embodiment of a two-stroke engine of the present invention having piston ports near TDC.

FIG. 23 shows a top cross section view of another embodiment of a two-stroke engine of the present invention.

FIG. 24 shows a front cross section view of a full-crank embodiment of a two-stroke engine of the present invention having piston ports near BDC.

FIG. 25 shows a detail view of the crank web valve of FIGS. 23 and 24.

FIG. 26 shows a front cross section view of a full-crank embodiment of a two-stroke engine of the present invention having piston ports near BDC.

FIG. 27 shows a top cross section view of another embodiment of a two-stroke engine of the present invention.

FIG. 28 shows a front cross section view of another embodiment of a two-stroke engine of the present invention.

FIG. 29 shows a side cross section view of another embodiment of a full-crank two-stroke engine of the present invention.

FIG. 30 shows a front cross section view of another embodiment of a full-crank two-stroke engine of the present invention.

FIG. 31 shows a front cross section view of another embodiment of a full-crank two-stroke engine of the present invention.

FIG. 32 shows a top section view of another embodiment of a two-stroke engine of the present invention.

FIG. 32A shows a side view of a piston with a channel.

FIG. 33 shows a top section view of another embodiment of a two-stroke engine of the present invention.

FIG. 34 shows a side cross section of another embodiment of a two-stroke engine of the present invention.

FIG. 35 shows a timing diagram for a two-stroke engine having a reed valve controlled intake system as in the engine shown in FIG. 34.

FIG. 36 shows a detail view of an intake manifold of an embodiment of a two-stroke engine of the present invention.

FIG. 37 shows a detail view of an intake manifold of a two-stroke engine of the present invention.

FIG. 38 shows a detail view of an intake manifold of a two-stroke engine of the present invention.

FIG. 39 shows a side cross section detail view of an intake manifold of a two-stroke engine of the present invention.

FIG. 40 shows a side cross section of another embodiment of a two-stroke engine of the present invention.

FIG. 41 shows a side cross section of a fuel injector that may be used in the present invention.

FIG. 42 shows a side cross section of another fuel injector that may be used in the present invention.

FIG. 43 shows a lawn and garden, hand-held trimmer that may be used in the present invention.

FIG. 44 shows a side cross section view of another embodiment of a two-stroke engine of the present invention.

FIG. 45 shows a cross section view of the two-stroke engine of FIG. 44.

FIG. 46 shows a cross section view of the two-stroke engine of FIG. 44.

FIG. 47A shows a front cross section view of the two-stroke engine of FIG. 44.

FIG. 47B shows a front cross section view of the two-stroke engine of FIG. 44 with the engine near TDC.

FIG. 47C shows a front cross section view of the two-stroke engine of FIG. 44 with the engine near BDC.

FIG. 48 shows a cross section view of another embodiment of a two-stroke engine of the present invention.

FIG. 49 shows a cross section view of the two-stroke engine of FIG. 48.

FIG. 50 shows a side cross section view of the two-stroke engine of FIG. 48.

FIG. 51A shows a cross section view of an intake system for one embodiment of the two-stroke engine of the present invention.

FIG. 51B shows a cross section view of the intake system of FIG. 51A for one embodiment of the two-stroke engine of the present invention.

FIG. 52A shows a cross section view of another intake system for one embodiment of the two-stroke engine of the present invention.

FIG. 52B shows a cross section view of the intake system of FIG. 52A for one embodiment of the two-stroke engine of the present invention.

FIG. 53 shows a timing diagram for the two-stroke engine of FIG. 44.

FIG. 53A shows a timing diagram for the two-stroke engine of FIG. 48.

FIG. 54A shows a cross section view of a throttle valve for one embodiment of the two-stroke engine of the present invention.

FIG. 54B shows a cross section view of another throttle valve for one embodiment of the two-stroke engine of the present invention.

FIG. 55A shows a cross section view of the throttle valve of FIG. 54A.

FIG. 55B shows a cross section view of the throttle valve of FIG. 54B.

FIG. 56 shows a cross section view taken along line “A-A” of the throttle valve of FIG. 54A.

FIG. 57 shows a cross section view of another embodiment of a two-stroke engine.

FIG. 58 shows a cross section view of another embodiment of a two-stroke engine.

FIG. 59 shows a cross section view of another embodiment of a two-stroke engine.

### DETAILED DESCRIPTION

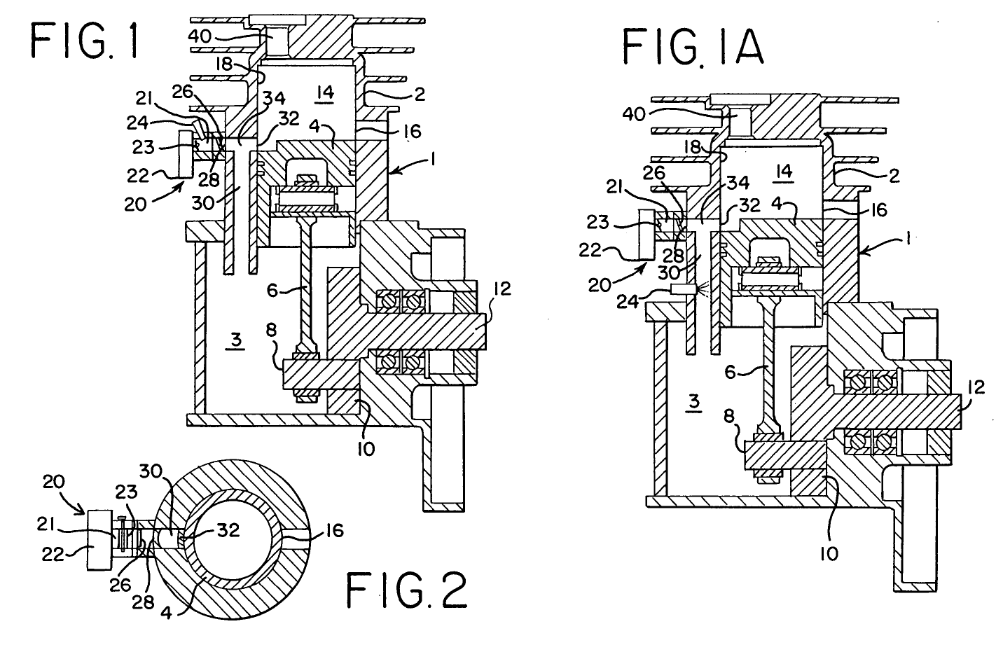

Referring now to FIGS. 1 and 2, one embodiment of a half-crank two-stroke engine 1 is shown. The engine 1 includes a cylinder 2 and a crankcase 3. A piston 4 is reciprocally mounted within the cylinder 2 and is connected by a connecting rod 6 to a crank throw 8 on a circular crank web 10 of a crankshaft 12. A combustion chamber 14 is formed in the cylinder 2 and is delimited by the piston 4. One end of the crankshaft 12 includes the crank web 10 for weight compensation and rotational balancing.

The combustion chamber 14 is connected through an exhaust port 16 formed in the cylinder wall 18 to an exhaust gas-muffler or similar exhaust-gas discharging unit (not shown). The exhaust port 16 permits exhaust gas to flow out of the combustion chamber 14 and into the exhaust gas-muffler.

The engine 1 includes a scavenging system including at least one transfer passage 30 between the crankcase 3 and the combustion chamber 14. The transfer passage 30 is used for scavenging and allowing a fresh fuel-air charge to be drawn from the crankcase 3 into the combustion chamber 14 through a transfer port 32 in the cylinder wall 18 at the completion of a power stroke. The transfer passage 30 may be formed as an open channel in the cylinder wall 18 so that it is open. Alternately, the transfer passage 30 may be formed as closed passage in the cylinder wall 18, with openings at each end.

An intake system 20 supplies the scavenging air and the fuel-air charge necessary to operate the engine 1. The intake system 20 is formed as a single air passage 21 connected to the top portion 34 of the transfer passage 30 and includes an air filter 22, a throttle valve 23, a fuel injector 24, a reed valve 26, and an inlet port 28 formed in the wall 18 of the cylinder 2. As seen in FIG. 1, the fuel injector 24 is positioned upstream of the reed valve 26. This placement will improve sealing and lubrication of the reed valve 26. Because the fuel used in a two-stroke engine is generally premixed with oil, the injected fuel-oil mixture will form a thin layer of oil film on the surface of the reed petal (not shown) of the reed valve 26. This oil layer helps seal the surfaces between the reed petal and the reed block (not shown). In addition, fuel contacting the reed petal will cool the petal.

The throttle valve 23 controls the amount of air that flows into the engine 1. A butterfly valve may be used for throttle valve 23, although other types of valves may also be used. When the pressure in the transfer passage 30 and crankcase 3 drops below ambient pressure, the reed valve 26 opens, allowing fresh air to flow through the air filter 22 and into the transfer passage 30 and crankcase 3. A control algorithm may be used to control the injection of fuel from the fuel injector 24. The control algorithm may monitor engine parameters such as crankshaft position, engine speed, engine torque, throttle position, exhaust temperature, intake manifold pressure, intake manifold temperature, crankcase pressure, ambient temperature and other operating conditions affecting engine performance. Examples of such control algorithms are described in U.S. Pat. No. 5,009,211, issued Apr. 23, 1991, and entitled Fuel Injection Controlling Device for Two-Cycle Engine, and U.S. Pat. No. 5,050,551, issued Sep. 24, 1991, and entitled System For Controlling Ignition Timing and Fuel Injection Timing of a Two-Cycle Engine, the contents of which are hereby incorporated by reference.

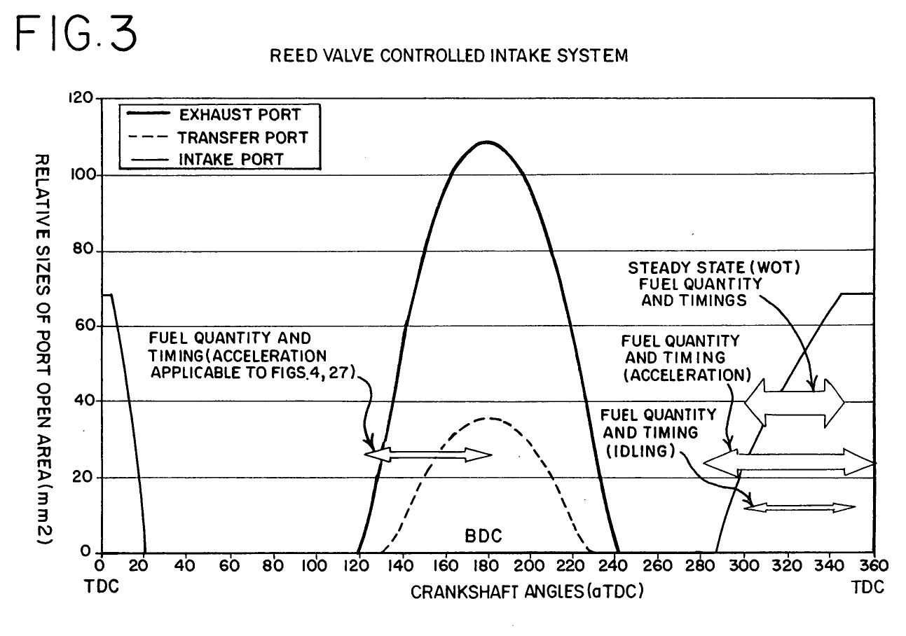

FIG. 3 illustrates a timing diagram of the engine 1 having a reed valve controlled intake system. The rotation in degrees of the crankshaft 12 is plotted along the x-axis, while the y-axis represents the relative sizes of the port areas for the transfer port 32 and exhaust ports 16, showing that exhaust port 16 area is greater than the transfer port 32 area. In operation, as the piston 4 is at a bottom dead center position (BDC), the exhaust port 16 is open to exhaust gases from the combustion chamber 14 to ambient. In addition, the transfer port 32 is also open, inducting scavenging air and the fuel-air charge from transfer passage 30 and crankcase 3 to combustion chamber 14. Scavenging air flows into the combustion chamber first, before the fuel-air mixture. This scavenging process flushes the combustion chamber 14 of combustion products and reduces the amount of fuel-air mixture that is directly short-circuited through the exhaust port 16. As the piston 4 rises, first the transfer port 32 and then the exhaust port 16 are closed. As the piston 4 continues to rise, the pressure in the crankcase 3 drops below ambient, which opens reed valve 26. This inducts fresh scavenging air through the air filter 22 and inlet port 28 into the top portion 34 of transfer passage 30.

The fuel injector 24 injects fuel directly into the scavenging air to form a fuel-air mixture. This fuel-air mixture flows through the inlet port 28 into the top portion 34 of transfer passage 30, eventually reaching the crankcase 3. The stratification is determined by the duration of the fuel injection, while the start and end of the fuel injection depends on the operating condition of the engine 1. For example, for a steady state operating condition, the fuel injection ends before the induction of air. As a result, only air continues to flow into the transfer passage 30, which leaves a scavenging air layer in the transfer passage 30, with the fuel-air mixture in the crankcase 3. For a cold start, the fuel injection may start early and end late, resulting in a richer fuel-air mixture and with little or no stratification. During engine idling or warm-up, the stratification may be achieved or increased gradually. For engine acceleration, the fuel injection may start slightly sooner than the inlet port 28 opening and continue past the end of fuel injection for a steady state, but before the end of induction of air. This provides an extra rich fuel-air mixture. For engine deceleration, it may be possible to cut off fuel completely or inject only a small fraction of fuel-oil mixture to help lubricate the parts if the deceleration occurs for an extended length of time. The algorithm may also be designed so that the injector 24 cuts off fuel completely for skip injection during idling, where the engine 1 fires intermittently to save fuel and lower emissions.

As the piston 4 reaches a top dead center position (TDC), fuel and air in the combustion chamber have been compressed and a spark plug 40 ignites the mixture. The resulting explosion drives the piston 4 downward. As the piston 4 moves downward, the fuel-air mixture in the crankcase 3 is compressed, increasing the pressure in the crankcase 3 and closing reed valve 26. As the piston 4 approaches the bottom of its stroke, the exhaust port 16 and the transfer port 32 are opened, repeating the cycle described above.

FIG. 1A illustrates an alternate position for the fuel injector 24 of the two-stroke engine 1 where the fuel injector 24 is repositioned to inject fuel directly into the transfer passage 30. As described further below, this placement of fuel injector 24 may improve the stratification of the fuel-free scavenging air in the transfer passages 30 and the fuel-air mixture in the crankcase 3.

As shown in FIG. 3, the fuel injector supplies fuel during steady state operation in an injection starting at least 5° after air begins to be inducted into the transfer passage and ending no later than 5° before top dead center. The fuel injector supplies fuel during acceleration in two injections. One of the injections during acceleration supplies fuel during at least a portion of time air is inducted into the combustion chamber. Another injection supplies more fuel than the injection during induction into the combustion chamber and starts before the injection during steady state operation starts and ends after the injection during steady state operation ends. The fuel injector supplies fuel during idle in an injection starting after air begins to be inducted into the transfer passage and ending before top dead center. This timing may be used with a two-stroke engine where all the air flows to the transfer passage from the intake system. The fuel injector may also be disposed near the transfer passage. A crank web may also be used as described herein to open and close the transfer passage in the crankcase as the crank web rotates.

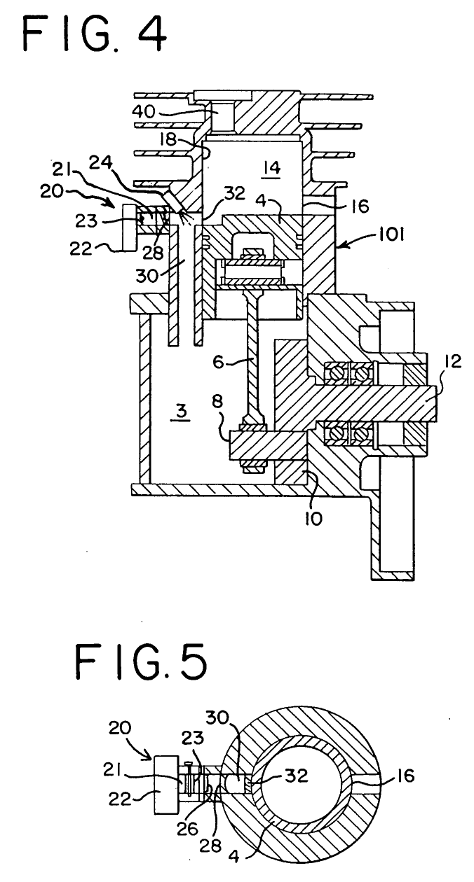

A second embodiment of a two-stroke engine 101 is illustrated in FIGS. 4 and 5. The fuel injector 24 is positioned downstream of the reed valve 26, closer to the piston 4. This downstream placement of the fuel injector 24 may help cool the piston 4. By injecting fuel closer to the piston 4 or by having the fuel impinge on the piston helps to cool the piston due to the heat of vaporization of the fuel. The fuel is at a lower temperature (ambient) than the surface temperature of the piston. The fuel that impinges on the piston skirt or surface absorbs the heat from the piston and cools it. Other aspects of engine 101 are similar to the engine 1 shown in FIGS. 1 and 2 and described above.

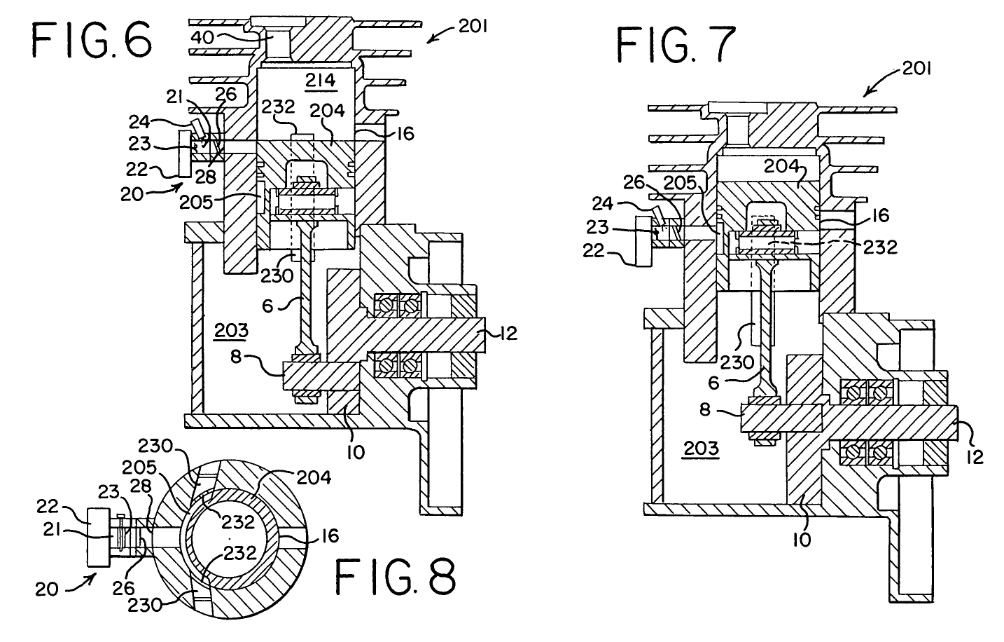

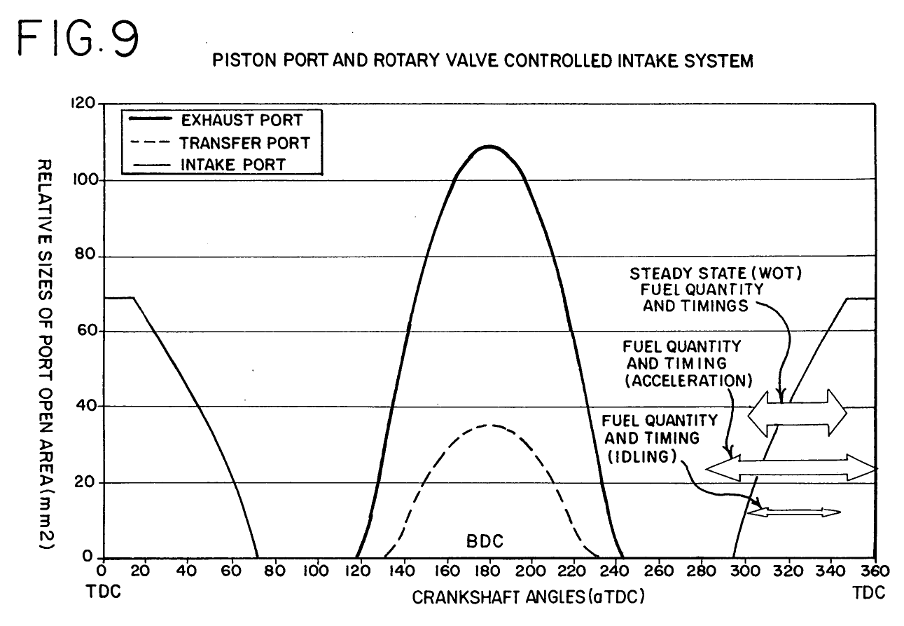

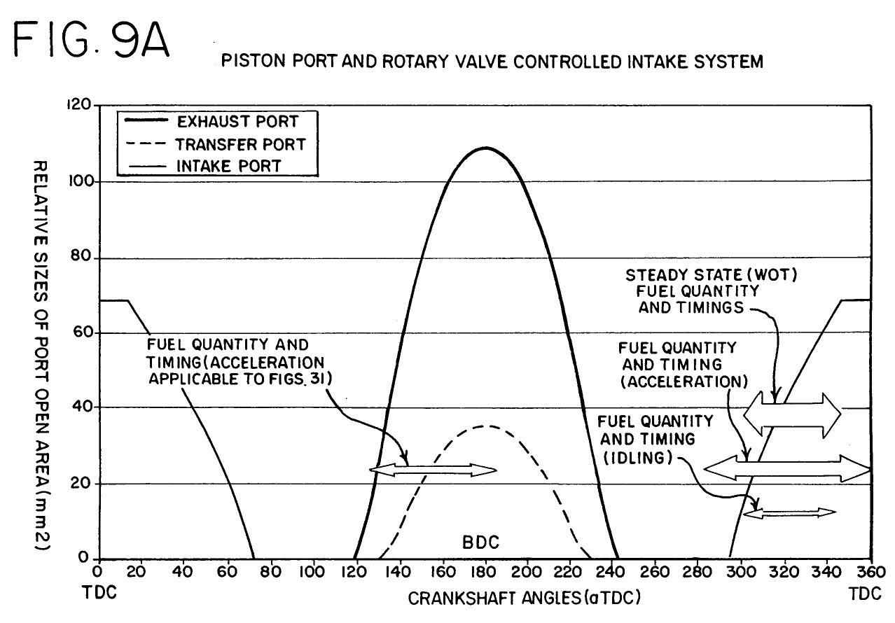

A third embodiment of a two-stroke engine 201 is illustrated in FIGS. 6-8. Engine 201 has a piston 204 with a circumferential channel 205. This circumferential channel 205 is alignable with the inlet port 28 and transfer ports 232. As the circumferential channel 205 is aligned with the inlet port 28 and the transfer ports 232, the air and fuel-air mixture from inlet port 28 flows through the channel 205 to transfer ports 232 into a pair of transfer passages 230. Circumferential channel 205 may also be formed as a slot, groove, cut-out, or other shape. FIG. 9 illustrates the timing diagram of the engine 201 having a piston-ported controlled intake system. The timing sequence is similar to that described in FIG. 3. As with FIG. 3, the rotation in degrees of the crankshaft 12 is plotted along the x-axis of FIG. 9, while the y-axis of FIG. 9 represents the relative sizes of the port areas for the transfer port 232 and exhaust ports 16, showing that exhaust port 16 area is greater than the transfer port 232 area.

In operation, as the piston 204 is at BDC, the exhaust port 16 is open to exhaust gases from the combustion chamber 214 to ambient. In addition, the transfer port 232 are also open, inducting stratified scavenging air and a fuel-air charge from the pair of transfer passages 230 and crankcase 203 to combustion chamber 214. Scavenging air flows into the combustion chamber first, before the fuel-air mixture. As the piston 204 rises, the sidewall of the piston first closes the transfer port 332 and then the exhaust port 16. As the piston 204 continues to rise, the pressure in the crankcase 203 drops below ambient, which opens reed valve 26. This inducts fresh scavenging air through the air filter 22 and inlet port 28. When the circumferential channel 205 aligns with the transfer ports 232 and inlet port 28, gaseous communication is established between the intake system 20 and the transfer passages 230 and crankcase 203. This allows the scavenging air and the fuel-air mixture to flow through the inlet port 28 and into the transfer passages 230, eventually reaching the crankcase 203.

As the piston 204 reaches TDC, fuel and air in the combustion chamber have been compressed and a spark plug 40 ignites the mixture. The resulting explosion drives the piston 204 downward. As the piston 204 moves downward, the fuel-air mixture in the crankcase 203 is compressed, increasing the pressure in the crankcase 203 and closing reed valve 26. As the piston 204 approaches the bottom of its stroke, the exhaust port 16 and the transfer ports 232 are opened, repeating the cycle described above. Other aspects of engine 201 are similar to the engine 1 shown in FIGS. 1 and 2 and described above.

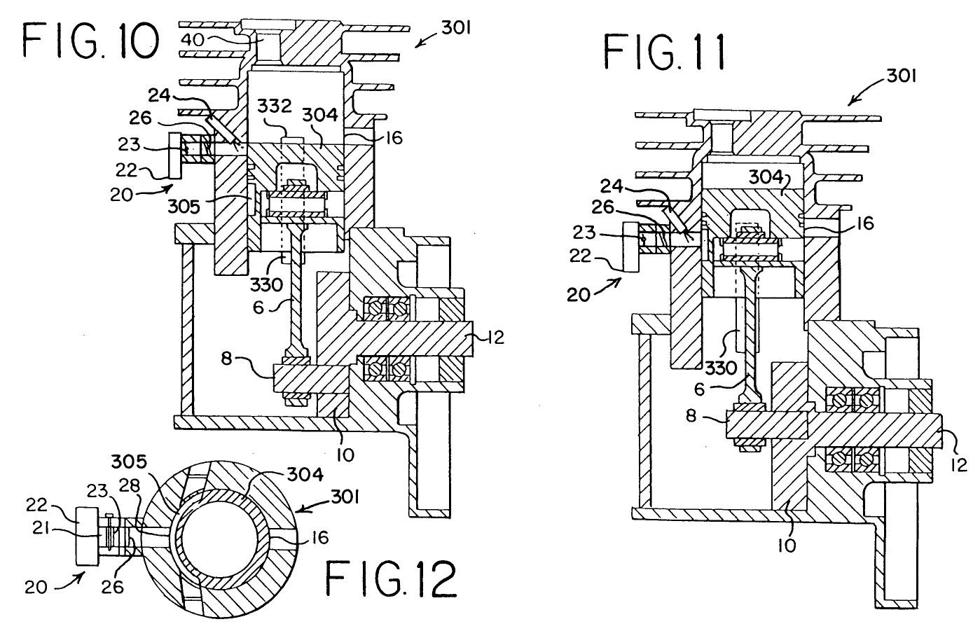

A fourth embodiment of a two-stroke engine 301 is illustrated in FIGS. 10-12. As with engine 101, the fuel injector 24 is positioned downstream of the reed valve 26, closer to the piston 304. This downstream placement of the fuel injector 24 may help cool the piston 304, as described above. Other aspects of engine 301 are similar to the engines 1 and 201 shown in FIGS. 1-3, 6-9 and described above.

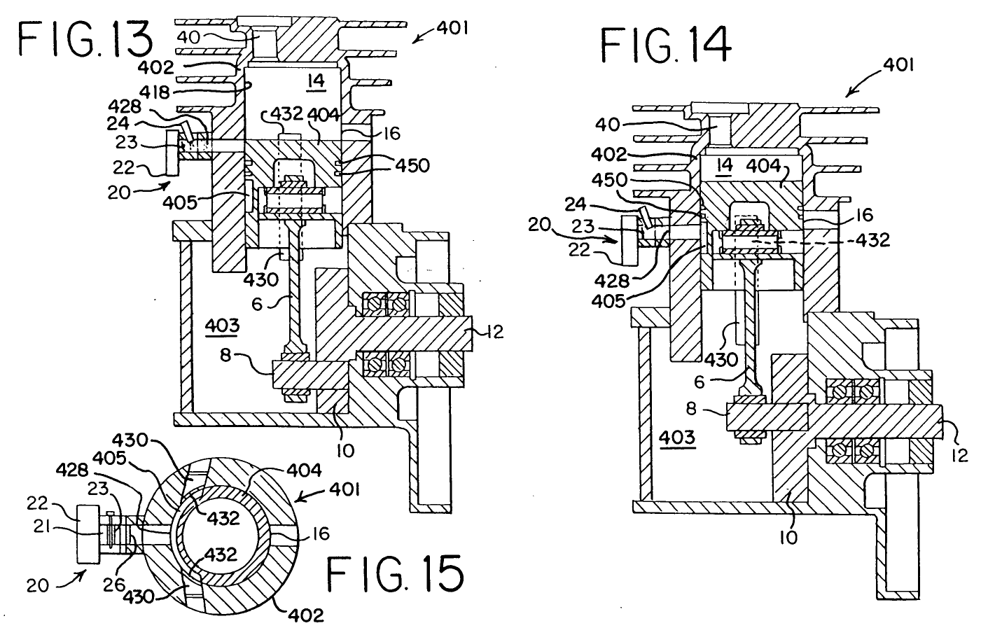

A fifth embodiment of a two-stroke engine 401 using a piston controlled loop scavenged system is illustrated in FIGS. 13-17. In engine 401, the reed valve used in the other embodiments described above is eliminated. Instead, the piston 404 is configured such that the transfer ports 432 of the transfer passages 430 are sealably closed by the reciprocating piston 404 in the cylinder 402. When the circumferential channel 405 is not aligned with the inlet port 428 and the transfer ports 432, a piston skirt 450 on the outer circumference of the piston 404 engages the cylinder wall 418, closing the transfer passages 430 to the inlet port 428. Only when the circumferential channel 405 is aligned with the inlet port 428 and the transfer ports 432 are the transfer passages 430 open. Other aspects of engine 401 are similar to the engines 1 and 201 shown in FIGS. 1-3, 6-9 and described above.

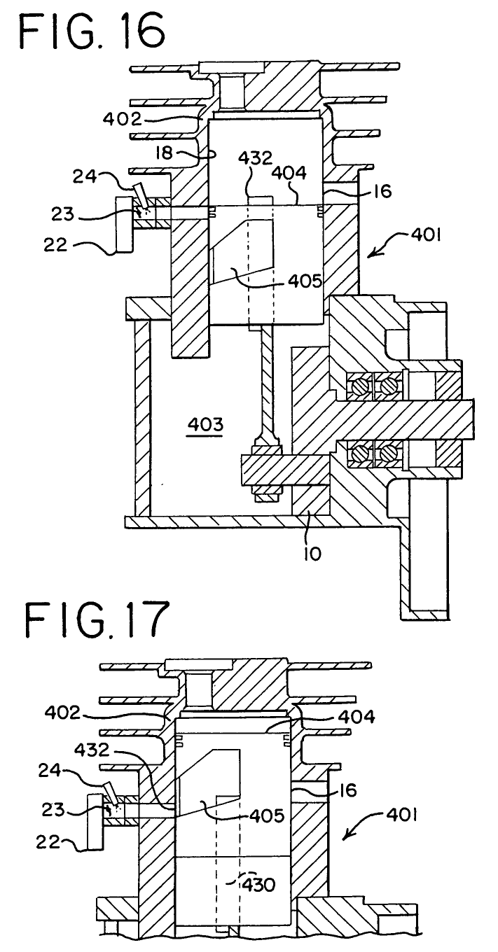

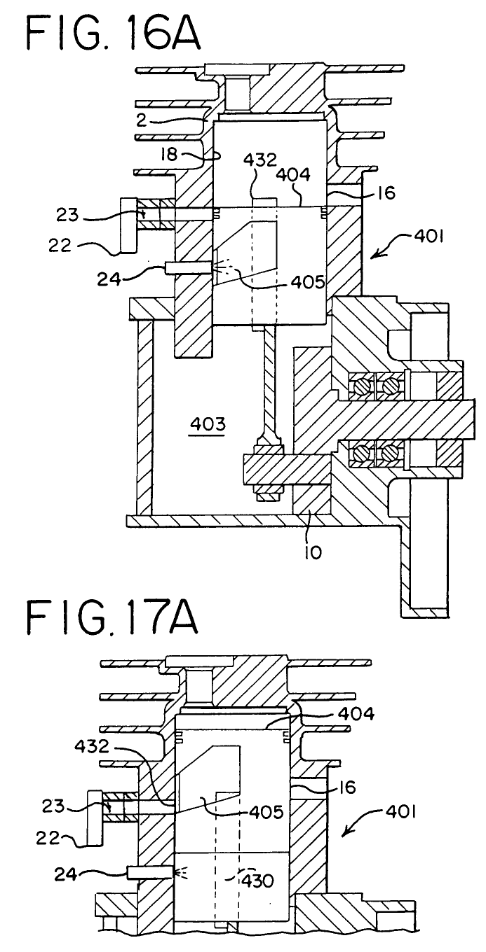

FIGS. 16A and 17A illustrate an alternate position for the fuel injector 24 of the two-stroke engine 401 where the fuel injector 24 is repositioned to inject fuel directly into the circumferential channel 405. As described further below, this placement of fuel injector 24 may improve the stratification of the fuel-free scavenging air in the transfer passages 430 and the fuel-air mixture in the crankcase 403.

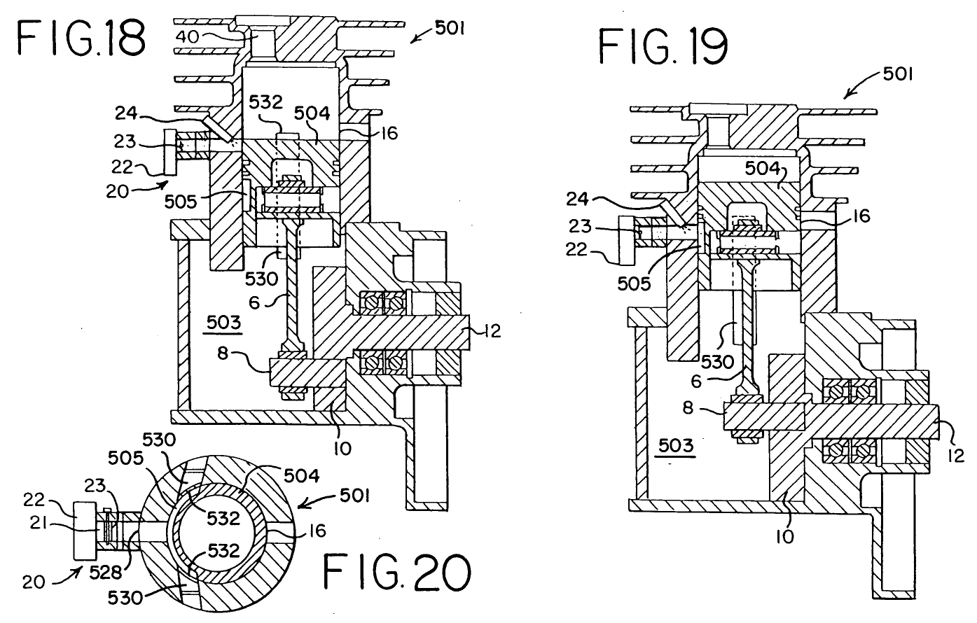

A sixth embodiment of a two-stroke engine 501 is illustrated in FIGS. 18-20. The fuel injector 24 is positioned closer to the piston 504. This placement of the fuel injector 24 may help cool the piston 504, as described above. Other aspects of engine 501 are similar to the engine 401 shown in FIGS. 13-17 and described above.

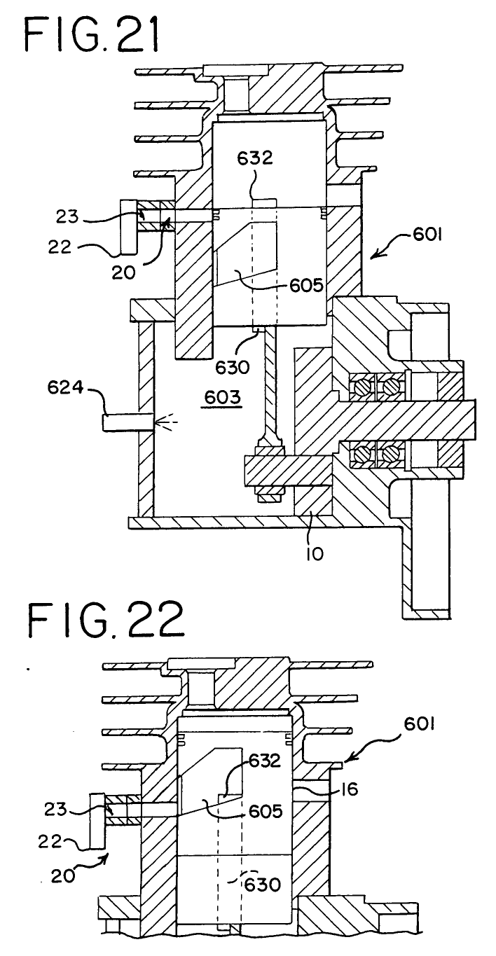

FIGS. 21-22 illustrate an alternate placement of the fuel injector 624. The fuel injector 624 is positioned in the crankcase 603, allowing for the direct injection of fuel into the crankcase 603. This placement of the fuel injector 624 may improve the stratification of the fuel-free scavenging air in the transfer passages 630 and the fuel-air mixture in the crankcase 603. In operation, the fuel injector 624 injects fuel directly into the crankcase 603. This fuel mixes with air inducted into the crankcase 603 from the transfer passages 630 to form a fuel-air mixture. Other aspects of engine 601 are similar to the engines described above.

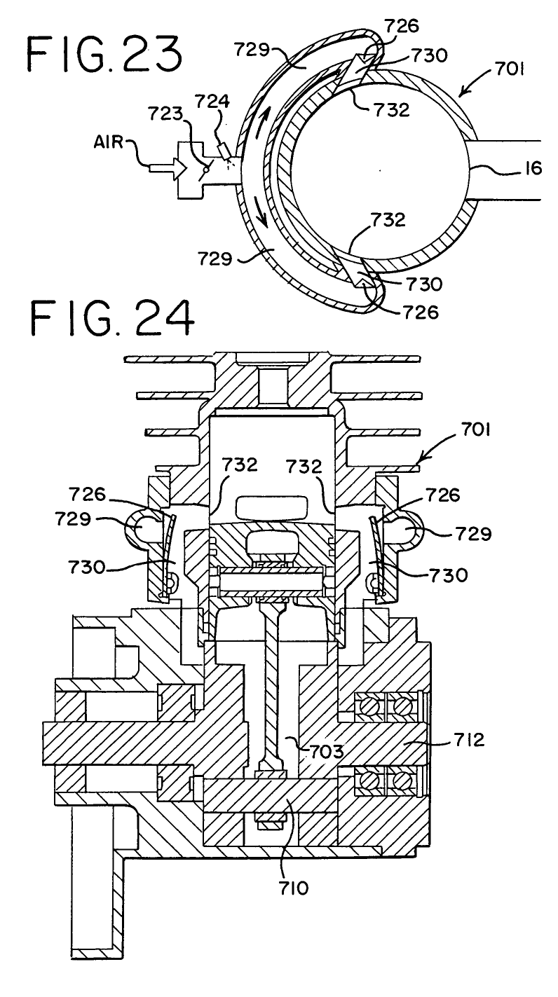

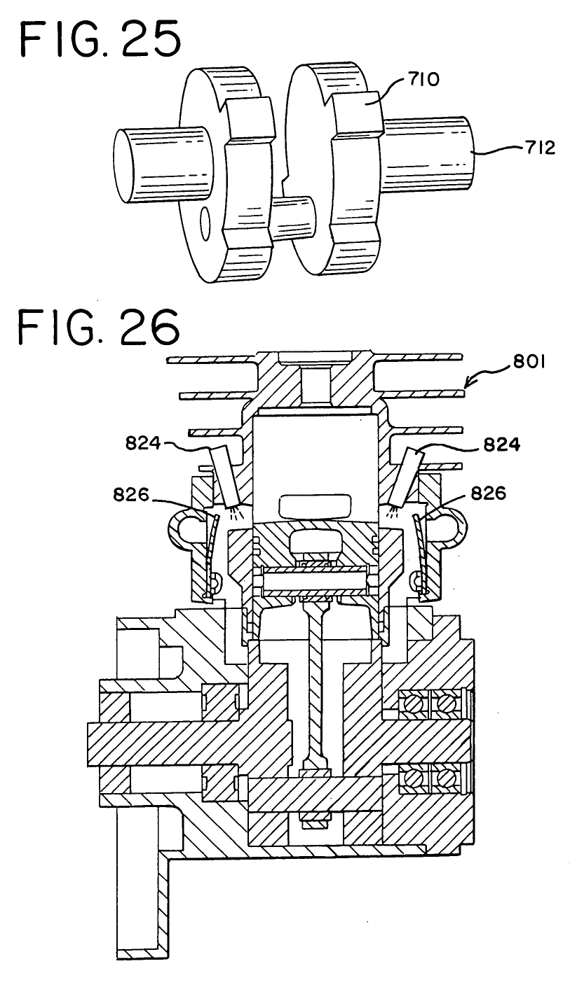

FIGS. 23-25 illustrate another embodiment of a two-stroke engine 701. The engine 701 is a full-crank engine, being rotatably supported by bearings on both sides of crankshaft 712. Reed valves 726 are positioned at both ends of a second air channel 729, which open into a pair of transfer passages 730. A fuel injector 724 is positioned upstream of the reed valves 726. Moreover, a rotary crank web 710 (best seen in FIG. 25) opens and closes the transfer passages 730 to start and end induction of the fuel-air mixture and air into the transfer passages 730 through the one-way reed valves 726. Once the induction of the fuel-air mixture and air into the transfer passages 730 and crankcase 703 is complete, which generally occurs a few degrees after TDC, the transfer passage 730 is shut-off by the crank web 710. As a result, the air retained in the transfer passage 730 is isolated from the mixture in the crankcase 703. This isolation retains the purity of the air in the transfer passage until the transfer passage 730 once again is opened by the crank web 710 for scavenging process, which can occur slightly before or after the transfer ports 732 are open. Other aspects of engine 701 are similar to the engine 1 shown in FIGS. 1-3 and described above. It should also be noted that the engine 701 of the present invention incorporates components that are similar in design and/or function as those described in U.S. Patent Application No. 2004/0040522, filed May 28, 2003, and entitled Two Stroke Engine With Rotatably Modulated Gas Passage. The contents of this patent are hereby incorporated by reference to avoid the unnecessary duplication of the description of these similar components. A detailed description of the operation of the rotary crank web 710 may also be found in the 2004/040522 Application.

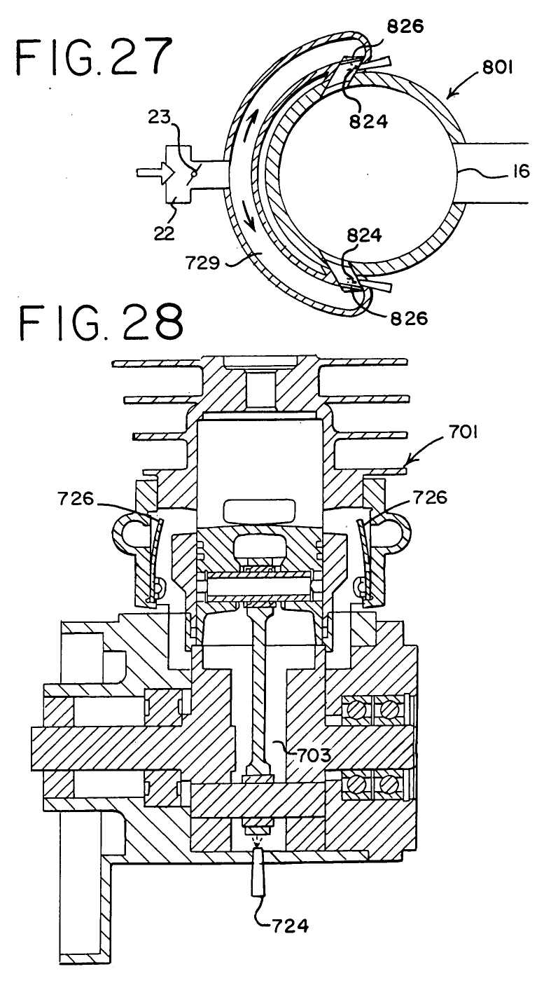

Another embodiment of a two-stroke engine 801 is illustrated in FIGS. 26-27. A pair of fuel injectors 824 are positioned downstream of one-way reed valves 826. By using two injectors 824, the injector size may be reduced in larger engines. This would allow the operation of only one injector during low load or idle conditions. Also, for pulse injection systems, by positioning the injectors downstream of the one-way reed valves and located to inject directly into the transfer passage or near the transfer port, a small fraction of fuel may be injected into the stream of lean fuel-air mixture during the late part of the scavenging process. As a result, the stratification of the mixture is enhanced, such that substantially fuel-free air flows first into the combustion chamber, followed by a pre-mixed lean mixture that was mixed during the induction process and in the crankcase, and followed last by the rich mixture. As a result, the fuel economy is maximized while the emissions are minimized. FIG. 9a illustrates the fuel injection sequence when the injector is located down stream of the reed valves or when fuel is injected directly into the transfer passage or near transfer ports. The hatched area shows that fuel is injected late during scavenging process also. Other aspects of engine 801 are similar to the engine 701 shown in FIGS. 23-25 and described above.

FIG. 28 illustrates the two-stroke engine 701 where the fuel injector 724 is repositioned to inject fuel directly into the crankcase 703. As described above, this placement of fuel injector 724 may improve the stratification of the fuel-free scavenging air in the transfer passages 730 and the fuel-air mixture in the crankcase 703.

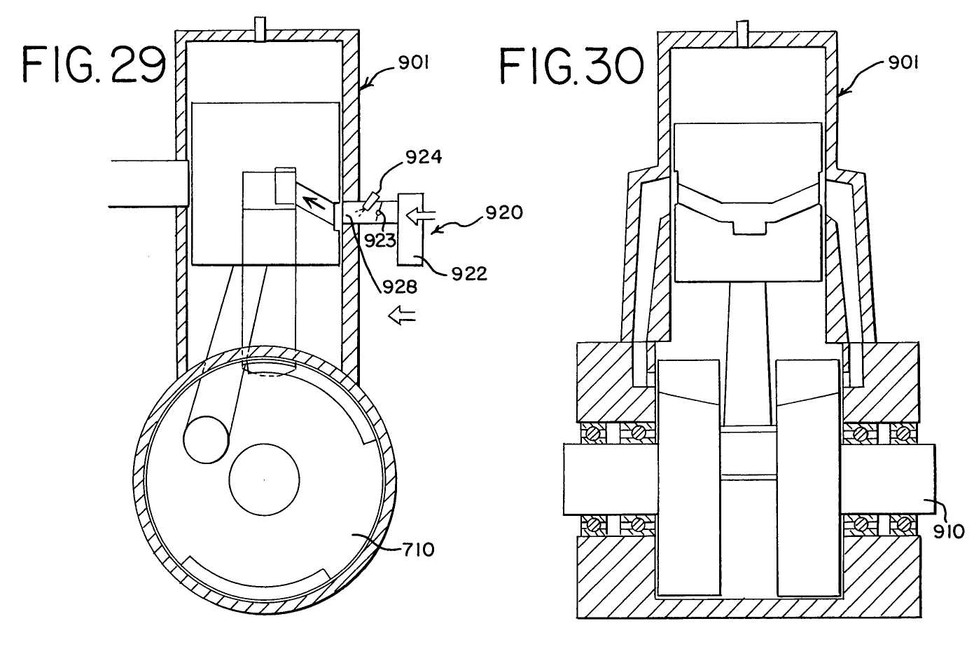

FIGS. 29-30 illustrate a full-crank piston-ported two-stroke engine 901. A crank web valve 710, illustrated in FIG. 25 and described in U.S. Patent Application No. 2004/0040522, filed May 28, 2003, and entitled Two Stroke Engine With Rotatably Modulated Gas Passage, controls the timings of opening and closing of transfer passages and thus the scavenging processes. The fuel injector 924 is located at the inlet port 928. Other aspects of engine 901 are similar to the engines described above. In addition, the crank web valve 710 may be used in any of the engines 1, 101, 201, 301, 401, 501, 601, 701, 801, 901 described above. The crank web valve 710 may be used along with the reed valves or piston porting. Moreover, the crank web valve reduces the mixing that may occur between the stratified pure air in the transfer channels and the fuel-air mixture in the crankcase.

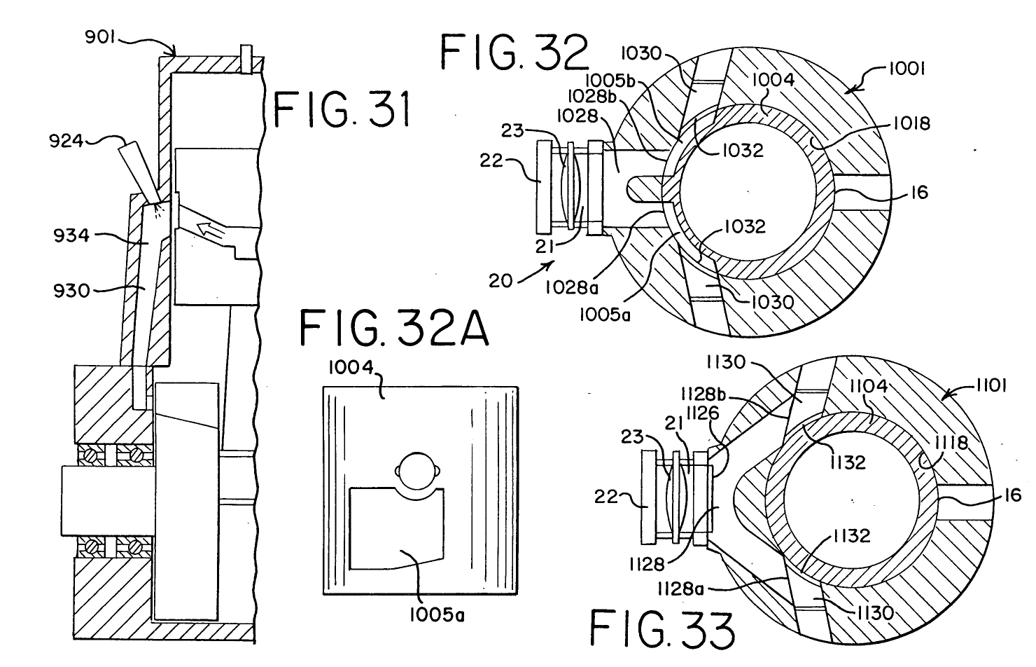

FIG. 31 illustrates the full-crank engine 901 wherein the fuel injectors 924 are positioned at the top portion 934 of the transfer passages 930. As described above for engine 801, by using two injectors 924, the injector size may be reduced in larger engines. This would allow the operation of only injector during low load or idle conditions. In addition, a small fraction of fuel may be injected into the stream of lean fuel-air mixture during the late part of the scavenging process.

FIG. 32 illustrates a two-stroke engine 1001. The inlet port 1028 is split into a first half 1028a and a second half 1028b. These halves 1028a and 1028b connect to transfer ports 1032. By splitting the inlet port 1028, halves 1028a and 1028b may be positioned closer to transfer ports 1032 and provide air to a pair of transfer passages 1030. The cavities 1005a, 1005b establish gaseous communication between the inlet ports 1028a, 1028b and the transfer ports 1032 respectively on either side of the intake system 20 and the exhaust port 16. The cavity 1005a in the piston 1004 is shown in further detail in FIG. 32A. The channels 1005a, 1005b may be shorter than single channel designs. Thus, by splitting the inlet into left and right sections or passages, it may be advantageous to provide short passages which may be useful in casting the piston. For example, the engine 1001 and the piston 1004 may be cast easier. Other aspects of engine 1001 are similar to the engine 501 shown in FIGS. 18-20 and described above. The location of the injector for the engine 1001 may be positioned in various locations as described herein.

FIG. 33 illustrates a two-stroke engine 1101. The inlet port 1128 is split into a first half 1128a and a second half 1128b. The reed valve 1126 permits air to pass to the first half 1128a and a second half 1128b of the inlet port 1128. These halves 1128a and 1128b connect to transfer ports 1132. By splitting the inlet port 1128, halves 1128a and 1128b and transfer ports 1132 may be positioned on either side of the exhaust port 16, allowing for loop scavenging. Other aspects of engine 1101 are similar to the engine 1 shown in FIGS. 1-2 and described above.

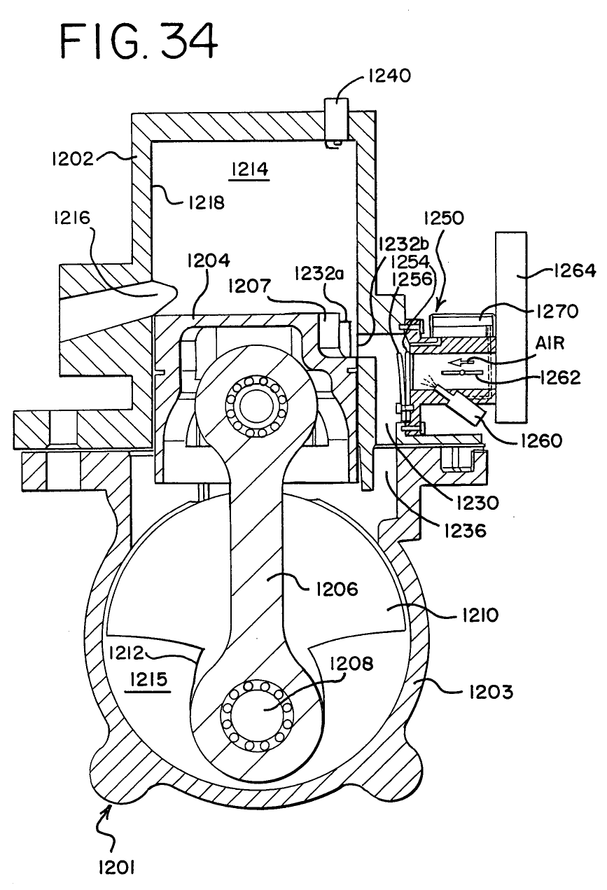

FIG. 34 illustrates another embodiment of a two-stroke engine 1201. The engine 1201 includes a cylinder 1202 and a crankcase 1203. A crankcase chamber 1215 is defined inside of crankcase 1203. A piston 1204 is reciprocally mounted within the cylinder 1202 and is connected by a connecting rod 1206 to a crank throw 1208 on a circular crank web 1210 of a crankshaft 1212. The piston 1204 is provided with a hollow 1207 formed in the upper surface. This hollow 1207 is located opposite a spark plug 1240 mounted in the upper surface of the cylinder 1202. Hollow 1207 and spark plug 1240 may be located off-center from the centerline of the piston 1204 and cylinder 1202.

A combustion chamber 1214 is formed in the cylinder 1202 and is delimited by the piston 1204. One end of the crankshaft 1212 includes the crank web 1210 for weight compensation and rotational balancing. The combustion chamber 1214 is connected through an exhaust port 1216 formed in the cylinder wall 1218 to an exhaust gas-muffler or similar exhaust-gas discharging unit (not shown). The exhaust port 1216 permits exhaust gas to flow out of the combustion chamber 1214 and into the exhaust gas-muffler. Piston hollow 1207 is formed to direct the flow of charge upward to keep the charge from directly flowing into the exhaust port 1216.

The engine 1201 includes a scavenging system with at least one transfer passage 1230 establishing gaseous communication between the crankcase chamber 1215 and the combustion chamber 1214. The transfer passage 1230 is used for scavenging and allowing a fresh fuel-air charge to be drawn from the crankcase 1203 into the combustion chamber 1214 through a transfer port 1232 in the cylinder wall 1218 at the completion of a power stroke.

An intake system 1250 supplies the scavenging air and the fuel-air charge necessary to operate the engine 1201. The intake system 1250 includes a reed valve having a reed petal 1254 and a reed plate 1256, a fuel injector 1260, a throttle valve 1262, and an air filter 1264. The intake system 1250 is mounted to the cylinder 1202, forming a cover for the transfer passage 1230.

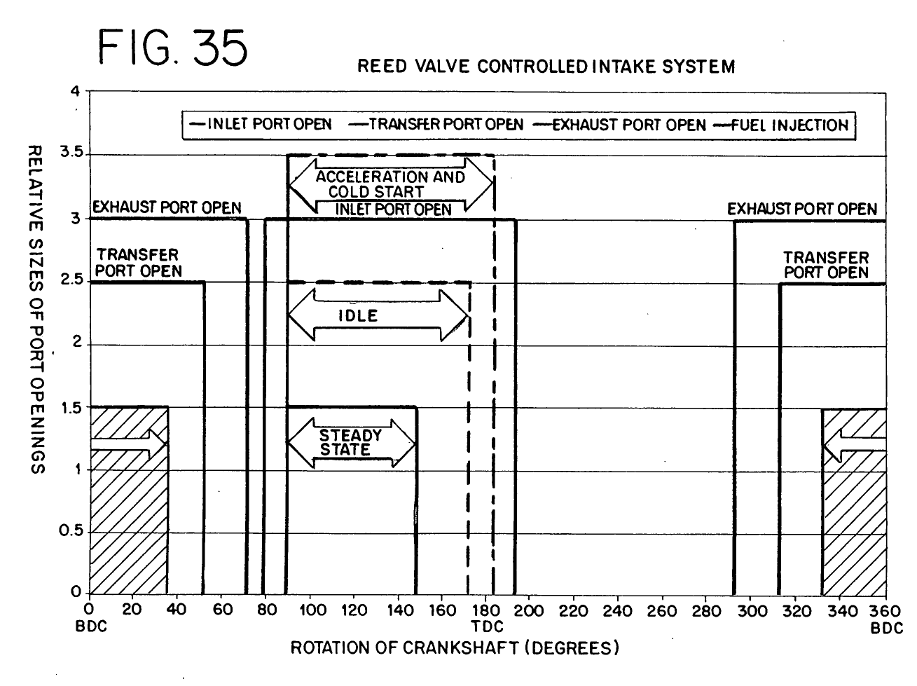

In operation, as the piston 1204 moves upward to TDC, the crankcase 1203 pressure drops. This pressure drop inducts air into the transfer passage 1230 through the reed petal 1254 and into the crankcase 1203 through a passage 1236 at the bottom of transfer passage 1230. As shown in the timing diagram illustrated in FIG. 35, the fuel injector 1260 injects fuel into the air, forming a fuel-air mixture. In this reed-valve controlled intake system, the pressure difference across the reed petal 1254 of reed valve determines the intake duration, while the throttle valve 1262 controls the amount of air flowing into the engine. The duration of fuel injection determines the stratification. In a steady state operating condition, the fuel injection ends well before the induction of air ends. As a result of ending the fuel early, only air continues to flow into the transfer passage 1230. As a result, air sits in-situ between the transfer port 1230 and the crankcase chamber 1215. Therefore, only substantially fuel-free air is filled in the transfer passage 1230.

The start and end of the injection of fuel into the intake air stream is dependent on the engine operating condition. For example, at cold start, it may be desirable to start the injection early and also end late, thus not having any stratification at all. During idling and warm up, the stratification may be achieved gradually as the engine warms up. During acceleration, the injection may start slightly sooner than the inlet timing and continue well past the end of injection for steady state, but before end of induction. As a result, while providing an extra rich mixture for acceleration, it may be possible to achieve stratification for improved emission. Also, stratification during idling may lower emission levels.

The timing plot illustrated in FIG. 35, which is similar to FIG. 3, shows the approximate port timings for the reed-valved engine 1201. The duration of fuel injection shown in the plot explains when the fuel is cut-off, after which time only air flows in to the transfer passage. Also, it may be possible to completely cut off fuel during deceleration.

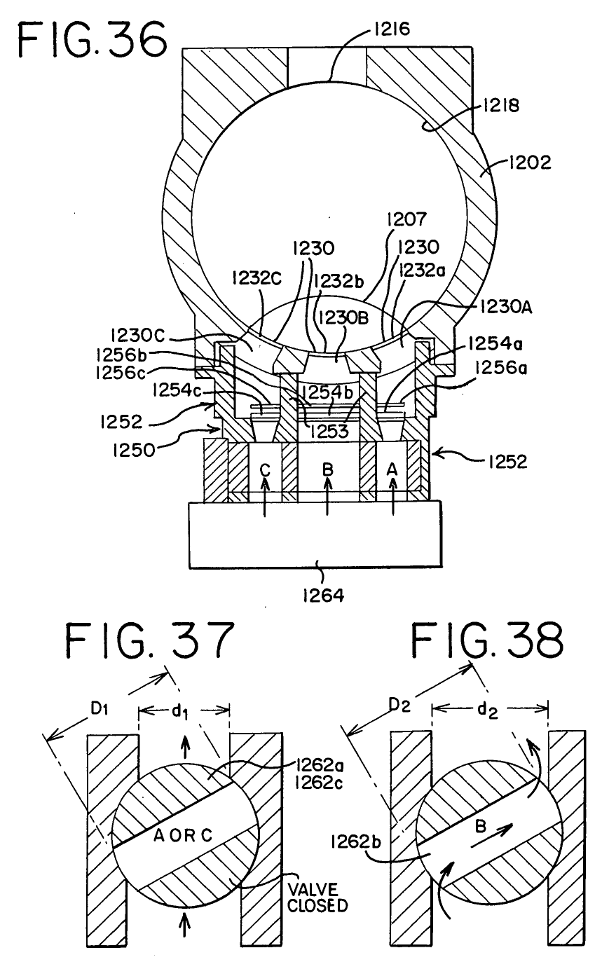

The intake system 1250 may also include a multi-barrel intake manifold 1252, as illustrated in FIG. 36. The intake manifold 1252 may separate the transfer passage 1230 into multiple passages 1230a 1230b 1230c through a plurality of ribs 1253. Such a multi-barrel intake system allows for regulating the air supply to individual transfer passages separately. While FIG. 36 illustrates manifold 1252 as having two ribs 1253 dividing the transfer passage 1230 into three passages 1230a 1230b 1230c, other numbers of ribs 1253 may be used to divide the transfer passage 1230 into other numbers of passages.

The intake manifold 1252 may also integrate the reed valve into one assembly. As seen in FIGS. 36-38, the air supply to individual transfer passages 1230a 1230b 1230c is regulated separately through the valves 1262a 1262b 1262c, respectively. These valves may be rotary throttle control valves, and are illustrated in FIGS. 37-38. The fuel injector 1260 provides fuel only to the middle passage 1230b. Also, the size of the inlet opening or throat does not have to be the same for each of the three passages 1230a 1230b 1230c. The inlet to the outside passages 1230a and 1230c are closed at idle and part throttle allowing more air into the middle passage 1230b. The fuel is injected (the fuel injector is not shown) into this stream of air. FIGS. 37 and 38 illustrate the outside valves 1262a 1262c and middle valve 1262b, respectively. At higher throttle, all three valves 1262a 1262b 1262c may be open. The size of the throat diameters d1 and d2 in relation to barrel diameters D1 and D2 is shown in FIGS. 37 and 38, with D1 being relatively larger than d1.

Further, because fuel is more or less constrained to flow through the middle passage 1230b, the air flow through the adjacent passages acts as an envelope of air for the fuel delivery into the combustion chamber. By staggering the transfer ports in such a way that the middle transfer port 1232b opens later than the side transfer ports 1232a and 1232c as the piston travels downward, air is allowed to enter the combustion chamber 1214 through the side transfer ports 1232a and 1232c before the fuel-air mixture enters the combustion chamber 1214 through the middle transfer port 1232b. Therefore, only substantially fuel-free air will be lost into the exhaust. Emissions may also be lower at idle and part throttle. This is shown in FIG. 34 where the opening of the side transfer port 1232a is positioned higher on the cylinder wall 1218 than the middle transfer port 1232b.

For engine 1201 seen in FIG. 34 with the multi-barrel manifold 1252 described above, the fuel injection can be timed to achieve ideal mixing of fuel and air. Also, since the fuel is injected early during intake, it goes into the crankcase 1203 for lubrication. Moreover, the churning of air and fuel in crankcase 1203 aids in mixing.

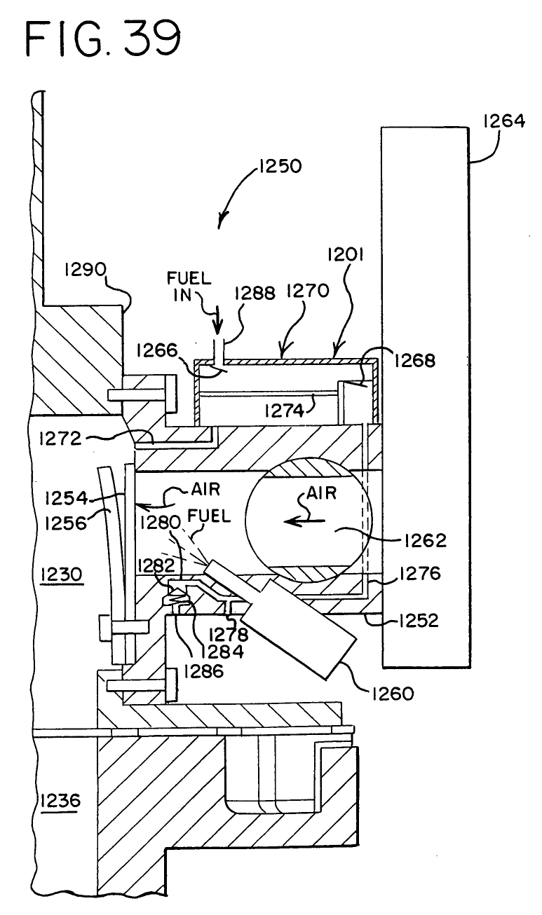

FIG. 39 illustrates the engine 1201, described above, with an integral fuel pump with the intake manifold 1252, which also houses the reed petals 1254a 1254b 1254c (only 1254b is shown in FIG. 39; 1254a and 1254c are shown in FIG. 36). The intake system 1250 is connected to the block 1290 of the two-stroke engine. In general, this embodiment of intake manifold 1252 may also be used in any of the other piston ported engines described herein in addition to the engine shown in FIG. 39.

The fuel pump 1270 operates similar to a pump in a carburetor, requiring a pulsating pressure signal from the crankcase 1203 (as seen in FIG. 34). For example, as shown in FIG. 39, a passageway 1272 may be provided between the transfer passage 1230 and a diaphragm 1274. As a result, when the piston rises, a pressure drop occurs in the transfer passage 1230 and the diaphragm passageway 1272. This causes the diaphragm 1274 to deflect away from the fuel inlet 1288 of the fuel pump 1270. The resulting negative pressure above the diaphragm 1274 causes the inlet flapper valve 1266 to open, and fuel is drawn into the fuel pump 1270. However, when the piston moves downward, a pressure rise occurs in the transfer passage 1230 and the diaphragm passageway 1272. This causes the diaphragm 1274 to deflect toward the fuel inlet 1288. The resulting positive pressure forces the inlet flapper valve 1266 closed and causes the fuel injector flapper valve 1268 to open. As a result, fuel is pumped into the fuel injector line 1276. Actual arrangement of the pump 1270 and the flapper valves 1266 and 1268 is similar to standard diaphragm carburetors, for example, ZAMA's H60E model and WALBRO's WYC 10.

The fuel injector line 1276 is routed to the fuel injector inlet (shown and described below), thereby supplying fuel to the fuel injector 1260. The fuel injector line 1276 may also be routed to a purge line 1278 if desired. The purge line 1278 may be connected to a purge bulb (e.g., a device with a one-way valve or other flow control device) to enable an operator to manually purge the fuel system of air. The fuel injector line 1276 may also be routed to a pressure regulator to control the fuel pressure to the fuel injector 1260. Preferably, the pressure regulator has a pressure chamber 1280 connected to the fuel injector line 1276. A pressure regulator valve 1282 is positioned within the pressure chamber 1280. The pressure regulator valve 1282 may be cone shaped as shown or any other shape adapted to control fluid flow. The pressure regulator valve 1282 is biased forward by a spring 1284 so that a forward surface of the valve 1282 seals against a circumferential surface of the pressure chamber 1280. As a result, when the fuel pressure in the fuel injector line 1276 exceeds a predetermined threshold, the fuel pressure forces the pressure regulator valve 1282 rearward against the spring 1284. This unseals the valve 1282 and allows fuel to flow to the pressure regulator outlet 1286, where it is routed back to the fuel reservoir.

As described above, the rotary throttle valve 1262 controls air flow into the intake system 1250. The rotary throttle valve 1262 may be a barrel valve 1262 as shown in FIG. 39 or may be a butterfly valve 1262 as shown in FIG. 34 or any other type of rotary throttle valve. The fuel injector 1260 injects fuel into the air flow as described above and further below. Preferably, an electronic control unit is used to control the fuel injector 1260. Passage of the fuel-air mixture into the transfer passage 1230 is controlled by the reed petal 1254b. Thus, when the piston rises, the resulting pressure drop across the reed valve causes the reed petal 1254 to open, and the fuel-air mixture is drawn into the transfer passage 1230. When the piston moves downward, the resulting pressure rise causes the reed petal 1254 to close and seal, thereby preventing further fuel-air mixture from flowing into the transfer passage 1230.

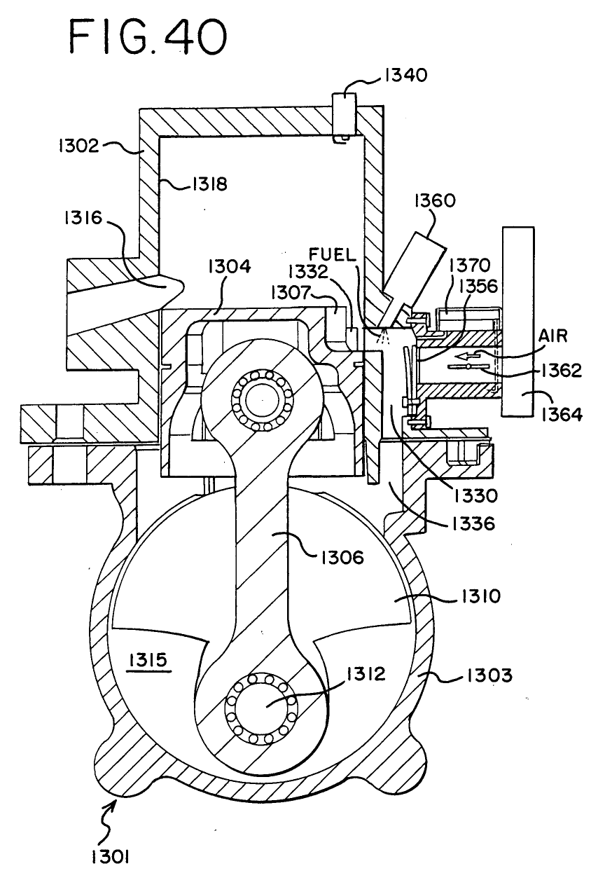

FIG. 40 illustrates engine 1301 where the fuel injector 1360 is positioned to inject fuel directly into the transfer passage 1330. The fuel may be injected in two phases. In the first phase, the fuel is injected early during the induction, so that fuel gets into the crankcase 1303 for lubrication. In the second phase, fuel is also injected during the late scavenging process, where charge flows from crankcase into combustion chamber. This results in a scavenging process where air is followed by lean mixture and then followed by rich mixture. Other aspects of engine 1301 are similar to the engines described above.

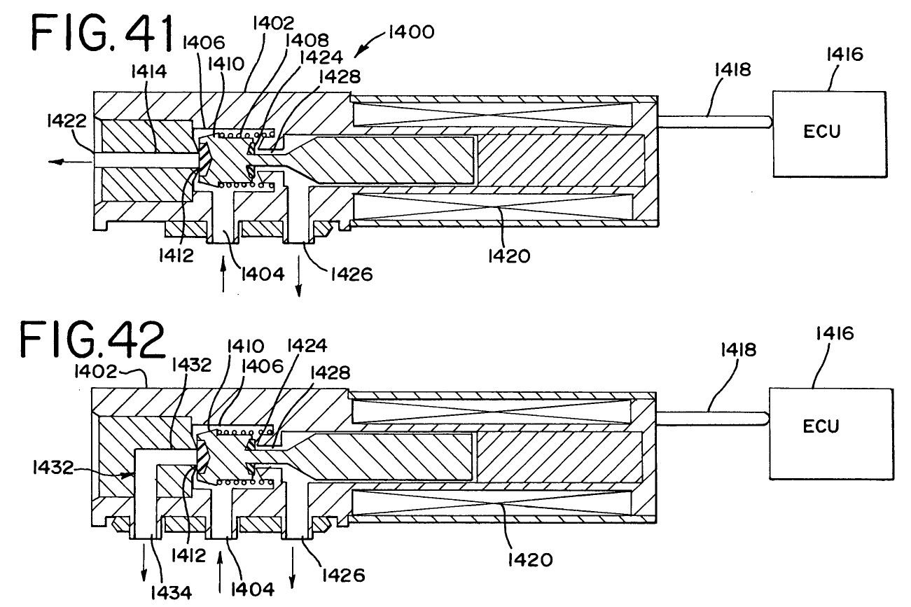

One type of fuel injector 1400 which may be used with the engines described above is shown in FIG. 41. The fuel injector 1400 is preferably designed to operate at low pressure and consume low power. An example of this type of fuel injector is provided by Lee Company as a control valve for fluid controls. For additional details on control valves from Lee Company, Lee Company's Technical Handbook, release 7.1 may be referred to.

The fuel injector 1400 has a valve body 1402 that houses the components of the fuel injector 1400 and may be connected to the intake system at the location where fuel injection is desired. Fuel enters the fuel injector 1400 through an inlet 1404 and fills a chamber 1406. A spring 1408 is positioned behind a portion of the plunger 1410 and biases the plunger 1410 forward. A seal 1412 is provided at the forward end of the plunger 1410. As a result, the spring 1408 causes the front seal 1412 of the plunger 1410 to seal against the outlet passage 1414.

Operation of the fuel injector 1400 is controlled by an electronic control unit (“ECU”) 1416. The ECU 1416 produces electrical signals representative of the fuel injection examples described above. The electrical signals are transmitted to the fuel injector 1400 through an electrical terminal 1418. The electrical signals from the ECU 1416 activate and deactivate an electro-magnetic coil 1420 in the fuel injector 1400 to control the duration and timing of the fuel which passes through the injector outlet 1422. For example, the electromagnetic coil 1420 may be activated by the ECU 1416 to force the plunger 1410 rearward against the spring 1408. This opens communication between the inlet 1404 and the outlet 1422 by moving the front seal 1412 away from the outlet passage 1414. A rear seal 1424 may also be provided behind a portion of the plunger 1410 to seal the rearward portion of the chamber 1406 when the outlet 1422 is opened to the inlet 1404. When the electromagnetic coil 1420 is deactivated by the ECU 1416, the spring 1408 forces the plunger 1410 forward until the front seal 1412 closes the outlet passage 1414.

A return port 1426 may also be provided. When the plunger 1410 is forced forward by the spring 1408 so that the front seal 1412 closes the outlet passage 1414, fuel may pass through the chamber 1406 and a coaxial passageway 1428 to the return port 1426. When the plunger 1410 is forced rearward by the electro-magnetic coil 1420 so that the rear seal 1424 closes the coaxial passageway 1428, fuel flow between the inlet 1404 and the return port 1426 is blocked. The return port 1426 is optional and may be eliminated if desired. However, the return port 1426 is preferred because it cools the fuel injector 1400 and helps to prevent air locks in the fuel system. The return port 1426 may also be connected to a purge valve to improve starting performance.

An advantage of the fuel injector 1400 shown in FIG. 41 is that it may be used with low cost, low pressure fuel pumps, such as the diaphragm pump 1270 shown in FIG. 39. For example, the fuel injector may be used with an operating pressure up to 1 to 10 psig. The fuel injector also has low power consumption. Typically, the power consumption may be about 250 to 550 miliwatts. The fuel injector also has long life and may operate more than 300 hours. In general, it is preferred that a premix of fuel and oil be used as the injection fluid in order to simultaneously provide fuel to the engine and lubricate the engine with a single fuel injector. However, other arrangements that inject only fuel through the fuel injector are also possible.

An alternative fuel injector 1430 is shown in FIG. 42. Most of the components of this fuel injector 1430 are the same as the fuel injector 1400 described above and shown in FIG. 41. Thus, it is unnecessary to repeat the full description. One difference with this fuel injector 1430 is that the outlet passage 1432 is angled so that the outlet 1434 is parallel with the inlet 1404 and the return port 1426. This may be advantageous in order to mount the fuel injector 1430 flush against the fuel intake system.

It will be appreciated that the above illustrated and described two-stroke engine provides a novel air and fuel intake configuration which may be used for improved scavenging and stratification. The two-stroke engine is particularly well suited for driving a flexible line trimmer for cutting vegetation, but it may also be used for a brush cutter having a rigid blade, or a lawn edger. The rotary engine incorporating such a fuel injection system may also be used for driving a hedge trimmer, vacuum, blower, snow blower, power hacksaw, circular saw, chain saw, water pump, lawn mower, generator or other hand-held power tools, for example.

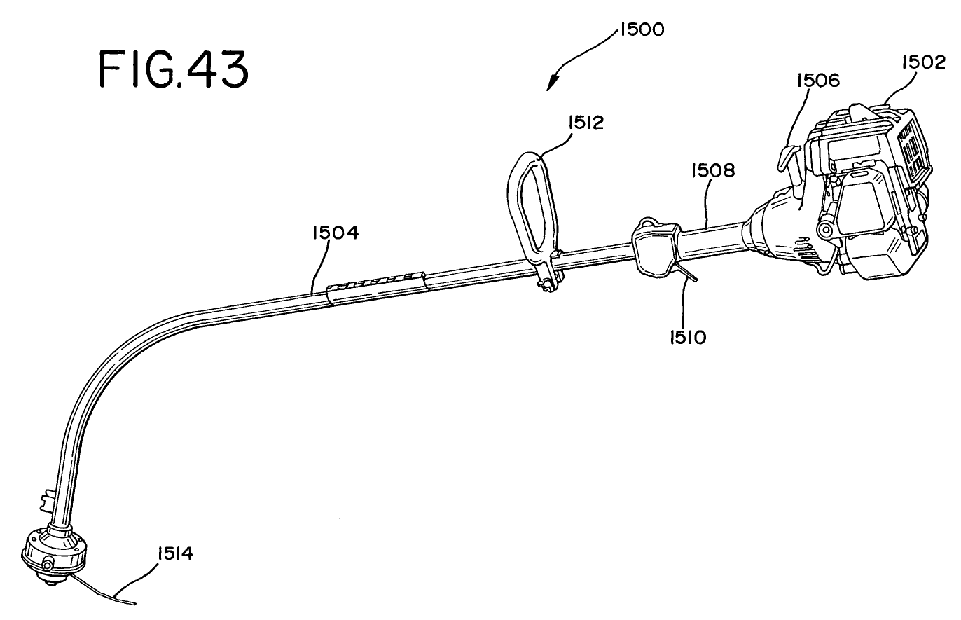

As shown in FIG. 43, the two-stroke engine may be used on a lawn and garden, hand-held flexible line trimmer 1500. Preferably, the two-stroke engine 1502 is mounted on the top end of the trimmer 1500. With this arrangement, the two-stroke engine 1502 provides balance to the trimmer 1500, and the drive shaft of the engine 1502 may be oriented to transfer rotational torque through the main tube 1504 of the trimmer 1500. A pull cord 1506, or another type of starter, may be provided to allow the operator to start the engine 1502.

A first handle 1508 may be provided adjacent the engine 1502 and coaxial with the main tube 1504. Preferably, the first handle 1508 is located near the center of gravity of the trimmer 1500. The first handle 1508 may also include a control lever 1510 to allow the operator to control the speed and/or power of the two-stroke engine 1502. A second handle 1512 may also be provided. The second handle 1512 is preferably located at a distance from the first handle 1508 that makes it comfortable for the operator to carry the trimmer 1500 by the first handle 1508 and the second handle 1512 at the same time. A rotating, flexible line 1514 is located at the bottom end of the trimmer 1500 and is typically used to cut grass and other law and garden vegetation. As well-understood by those skilled in the art, the rotating, flexible line 1514 is driven by the drive shaft of the engine 1502 through the main tube 1504.

One advantage of using the described two-stroke engine on a hand-held, lawn and garden piece of equipment is that two-stroke engines are relatively light weight and provide high power output per unit weight. Thus, in the case of the trimmer 1500 described above, the weight of the engine 1502 can be easily lifted by an operator. The engine 1502 also provides sufficient power to drive the rotating, flexible line 1514 for cutting desired vegetation or to operate other typical lawn and garden equipment. The two-stroke engines described above also may improve the operating performance of hand-held, lawn and garden equipment and lower combustion emissions.

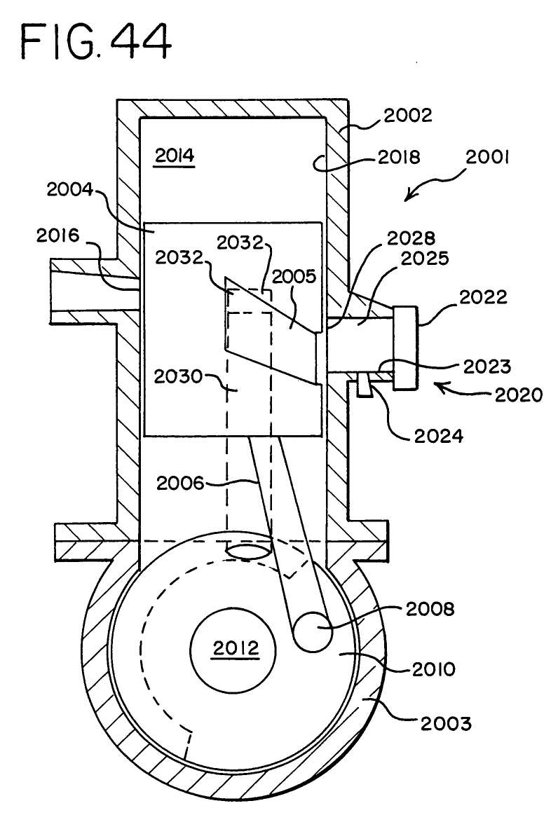

Referring now to FIGS. 44-47C, another embodiment of a two-stroke engine 2001 is shown. The engine 2001 includes a cylinder 2002 and a crankcase 2003 A piston 2004 is reciprocally mounted within the cylinder 2002 and is connected by a connecting rod 2006 to a crank throw 2008 on a circular crank web 2010 of a crankshaft 2012. A combustion chamber 2014 is formed in the cylinder 2002 and is delimited by the piston 2004. One end of the crankshaft 2012 includes the crank web 2010 for weight compensation and rotational balancing. This crank web 2010 may also act as a rotary valve to open and close the port at the bottom of the transfer passage 2030 as described in U.S. Patent Application No. 2004/0040522, described above.

The combustion chamber 2014 is connected through an exhaust port 2016 formed in the cylinder wall 2018 to an exhaust gas-muffler or similar exhaust-gas discharging unit (not shown). The exhaust port 2016 permits exhaust gas to flow out of the combustion chamber 2014 and into the exhaust gas-muffler.

The engine 2001 includes a scavenging system including at least one transfer passage 2030 between the crankcase chamber 2003 and the combustion chamber 2014. The transfer passage 2030 is used for scavenging and allowing a fresh fuel-air charge to be drawn from the crankcase chamber 2003 into the combustion chamber 2014 through a transfer port 2032 in the cylinder wall 2018 at the completion of a power stroke. The transfer passage 2030 may be formed as an open channel in the cylinder wall 2018 so that it is open. Alternately, the transfer passage 2030 may be formed as a closed passage in the cylinder wall 2018, with openings at each end. There can be more than one transfer passage on each side of the exhaust port. That is, there can be a total of four or more transfer passages between the crankcase chamber 2003 and the combustion chamber 2014.

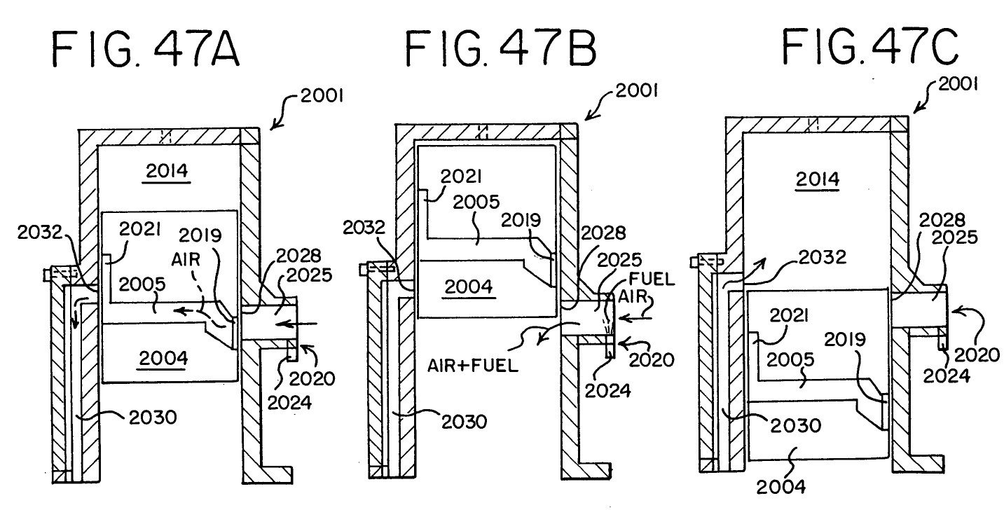

An intake system 2020 supplies the scavenging air and the fuel-air charge necessary to operate the engine 2001. The intake system 2020 is formed as a single passage 2025 connected to the engine 2001. The intake system 2020 includes an air filter 2022, a throttle valve 2023, a fuel injector 2024, and an inlet port 2028 formed in the wall 2018 of the cylinder 2002. As seen in FIGS. 44 and 47A, the inlet port 2028 is positioned such that when the piston 2004 is near a TDC position, the inlet port 2028 allows the intake system to communicate directly with the crankcase chamber 2003. As it can be seen the tip of the injector 2024 is flush with the inside wall of the passage 2025. The fuel is injected or sucked directly into the stream of air during the induction process into the crankcase chamber 2003.

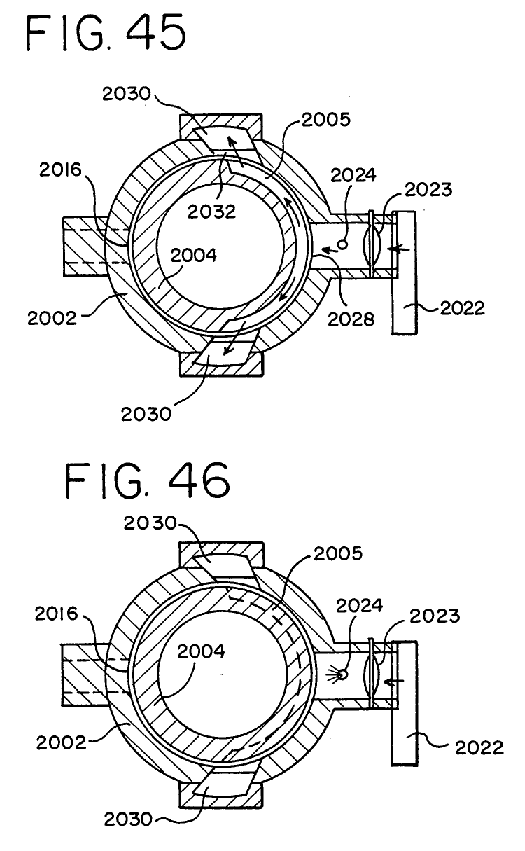

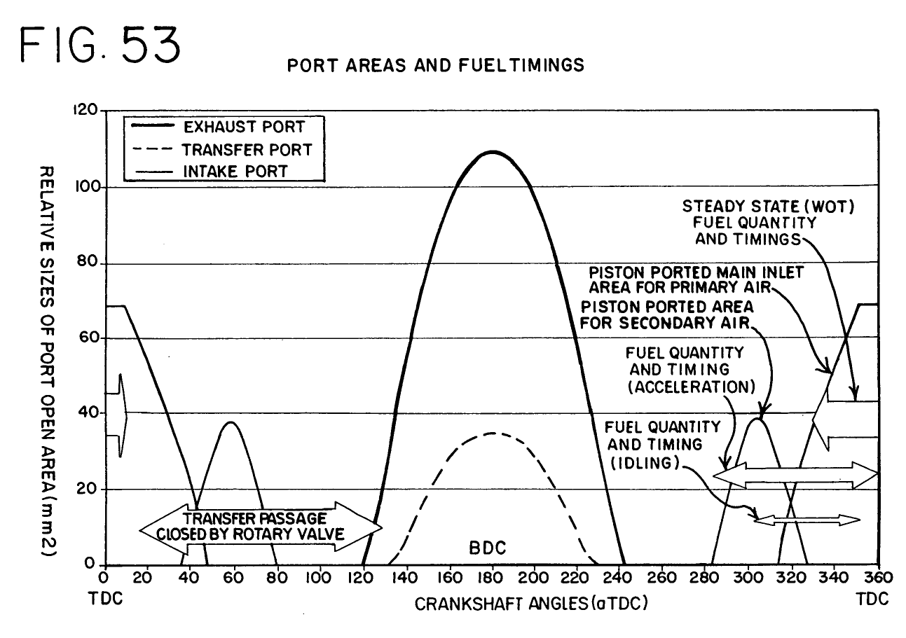

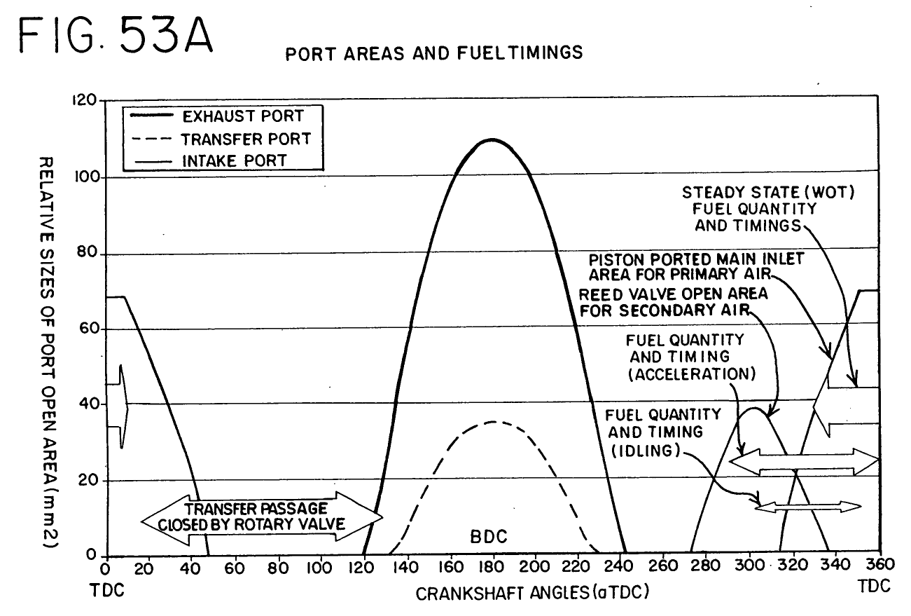

In addition, as seen in FIGS. 45-47C, piston 2004 is equipped with a circumferential channel 2005. The channel 2005 has a first section 2019 that is alignable with inlet port 2028. Similarly, the channel 2005 has a second section 2021 that is alignable with transfer ports 2032. The second section 2021 may align with all the transfer ports when there are more than two transfer ports as described above. As seen in FIGS. 47A-47C, the size and shape of sections 2019, 2021 may be adjusted to control the timing of the induction of air through the piston channel 2005 and into the transfer channels 2030. The timing is adjusted such that they align with the inlet port 2028 and transfer port 2032 during the early induction process, which is when the piston is traveling upward toward the TDC position. However, due to the symmetry of the port timing in the port controlled induction system, the sections 2019 and 2021 align again when the piston is traveling downward toward BDC. As seen in FIG. 53, a timing diagram illustrates the relative sizes for the openings of the exhaust port 2016, the transfer port 2030, and the intake or inlet port 2028 against the rotational position of the crankshaft 2012. For FIG. 53, the x-axis shows the crank angle of the crankshaft 2012, while the y-axis shows the port areas. The quantity of injected fuel is approximately shown by the sizes of the areas of the arrows. The arrows also show the start and end of fuel injection timings at different operating conditions.

In operation, as the piston 2004 is at a BDC position (see FIG. 47C), the exhaust port 2016 is open to the exhaust gases from the combustion chamber 2014 to ambient. In addition, transfer port 2032 is open, first inducting air and then a fuel-air charge from the transfer passage 2030 and crankcase 2003 to the combustion chamber 2014. Scavenging air flows into the combustion chamber 2014 first, before the fuel-air mixture. This scavenging process flushes the combustion chamber 2014 of combustion products and reduces the amount of fuel-air mixture that is directly short-circuited through the exhaust port 2016. As the piston 2004 rises, first the transfer port 2032 and then the exhaust port 2016 are closed as seen in FIG. 44.

As the piston 2004 continues to rise, the channel 2005 in the piston 2004 aligns with the inlet port 2028 and the transfer port 2030, permitting scavenging air to flow from ambient, through the channel 2005, and into the transfer passage 2030. This fresh scavenging air flushes the air-fuel mixture remaining from the previous cycle in the transfer passages 2030 back into the crankcase 2003. This induction of air continues until and after the piston 2004 uncovers the inlet 2028, which allows air to flow directly into the crankcase 2003 as seen in FIG. 47B. As seen in FIG. 53, for a steady state operating condition or for a 70% to 100% throttle open position, the fuel injector 2024 injects fuel into the fraction of the air that is inducted into the crankcase 2003 after the channel 2005 is closed during the induction process, that is when the piston is traveling upward to the TDC position.

For cold-start, idling, acceleration, and other engine operating conditions, it is possible to inject fuel into the air flowing through the channel 2005 and going into the transfer passage 2030 for improved startability or idling, and for improved throttle response for quicker acceleration. In addition, it is possible to provide for some stratification for cold-start, idling, or acceleration conditions. First, fuel may be injected into the air stream flowing into the transfer passage 2030. Next, the fuel injection is stopped so that substantially fuel free air flows into the transfer passage 2030. Finally, the fuel injection is started again when the piston 2004 opens the inlet port 2028, allowing for fuel to be injected directly into the crankcase 2003.

The stratification is determined by the duration of the fuel injection, while the start and end of the fuel injection depends on the operating condition of the engine 2001. Therefore, there is a buffer volume of substantially only air in the transfer passage 2030, and a fuel-air mixture in the crankcase 2003. This air-head or stratification minimizes the short circuit loss of fuel into the exhaust, which also reduces emissions. Other aspects of engine 2001 are similar to the engines described above. In addition, the engine 2001 may incorporate a rotary crank web as found in Patent Application No. 2004/040522. The timing for such a rotary crank web used to open and close the transfer passages 2030 at the crankcase 2003 is shown in FIG. 53. For effective stratification of the charge and to prevent any mixing of air-fuel in the crankcase chamber 2003 with the substantially pure air in the transfer passage 2030, the transfer passage 2030 is closed by the crank web when the piston starts its downward travel toward BDC. The crank web (or rotary valve) may close the lower end of the transfer passage a few degrees after TDC and will open again slightly before the transfer port 2032 is open for scavenging. This timing and operation is described in Patent Application No. 2004/040522. The angle between the leading and trailing edges of the cut out on the web determines the timing for the opening and closing of transfer passage into the crankcase chamber. An example of the crank web is shown in FIG. 25.

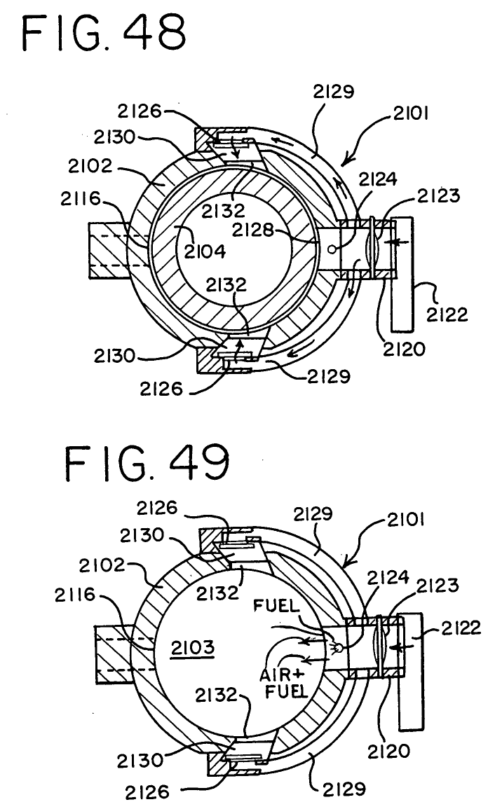

Another embodiment of a two-stroke engine 2101 is illustrated in FIGS. 48-50. Similar to the engine 2001, engine 2101 has an intake system 2120 that supplies the scavenging air and the fuel-air charge necessary to operate the engine 2101. The intake system 2120 is formed as a single passage 2121 connected to the engine 2101. The passage 2121 branches into a secondary passage 2129. As seen in FIGS. 48-49, the secondary passage 2129 wraps around the engine 2101, and is connected to transfer passages 2130 of the engine 2101. Reed valves 2126 are positioned at the junction between the passage 2129 and the transfer passages 2130. This secondary passage 2129 may also be integrally formed as a cast feature in engine 2101, similar to the cast halves 1128a and 1128b of the inlet port 1128 of engine 1101, described above and shown in FIG. 33. Again, there can be more than one pair of transfer passages as described above.

The intake system 2120 also includes an air filter 2122, a throttle valve 2123, a fuel injector 2124, and an inlet port 2128 formed in the wall 2118 of the cylinder 2102. Again, the tip of the injector 2124 is flush with the intake passage 2121, which eliminates dead pockets of fuel between the tip of the injector and the stream of intake air.

In operation, as the piston 2104 is at BDC, the exhaust port 2116 is open to exhaust gases from the combustion chamber 2114 to ambient. In addition, the transfer port 2132 is also open, inducting stratified scavenging air and a fuel-air charge from the transfer passages 2130 and crankcase chamber 2103 to combustion chamber 2114. Scavenging air flows into the combustion chamber first, before the fuel-air mixture. As the piston 2104 rises, the sidewall of the piston first closes the transfer port 2132 and then the exhaust port 2116. As the piston 2114 continues to rise, the pressure in the crankcase 2103 drops below ambient, which opens the reed valves 2126. This inducts fresh scavenging air through the air filter 2122 and passage 2121, into the branch passage 2129, and then through the transfer passages 2130 and into the crankcase chamber 2103 as seen in FIG. 48. As with engine 2001, described above, this fresh scavenging air flushes the air-fuel mixture remaining from the previous cycle in the transfer passages 2130 back into the crankcase 2103. This induction of air continues until and after the piston 2104 uncovers the inlet 2128, which allows air to flow directly into the crankcase 2003 as seen in FIG. 49.

As the piston 2104 reaches TDC, fuel and air in the combustion chamber are compressed and a spark plug (not shown) ignites the mixture. The resulting explosion drives the piston 2104 downward. As the piston 2104 moves downward, the fuel-air mixture in the crankcase 2103 is compressed, increasing the pressure in the crankcase 2103 and closing reed valve 2126. However, to prevent mixing of fresh air in the transfer passage 2130 with the air-fuel mixture in the crankcase chamber, the transfer passage 2130 may be closed by the crank web at the lower port 2115 as described above and explained in Patent Application No. 2004/040522. Closing of the transfer passages 2130 during downward travel of the piston 2104 helps maintain the purity of the air in the transfer passage 2130, which may be used for minimizing the loss of fuel into the exhaust port. As the piston 2104 gets closer to opening the transfer port 2132, the crank web opens the transfer passage 2130 at the lower port 2115 slightly before the piston 2104 opens the upper transfer port 2132. As the piston 2104 approaches the bottom of its stroke, the exhaust port 2116 and the transfer ports 2132 are opened, repeating the cycle described above. FIG. 53A is a timing diagram illustrating the relative sizes for the openings of the exhaust port 2116, the transfer port 2130, and the intake or inlet port 2128 against the rotational position of the crankshaft. For FIG. 53A, the x-axis shows the crank angle of the crankshaft, while the y-axis shows the port areas. The quantity of injected fuel is approximately shown by the sizes of the areas of the arrows. The arrows also show the start and end of fuel injection timings at different operating conditions. Other aspects of engine 2101 are similar to the engine 2001 shown in FIGS. 44-47C and described above. In addition, the engine 2101 may also incorporate a rotary crank web as found in Patent Application No. 2004/040522 described above. An example of the crank web is shown in FIG. 25. The timing which may be used for the rotary crank web to open and close the transfer passages 2030 at the crankcase 2003 is shown in FIG. 53.

As shown in FIG. 53, the fuel injector supplies fuel during steady state operation in an injection starting at least 5° after air begins to be inducted into the crankcase and ending no later than 20° after top dead center. Preferably, this injection starts after air stops being inducted into the transfer passage. The fuel injector supplies fuel during acceleration in an injection starting no more than 15° before air begins to be inducted into the transfer passage. The fuel injector supplies fuel during idle in an injection starting after the injection during acceleration starts and ending before the injection during acceleration ends.

FIGS. 51A-51B illustrate an alternate intake system 2220 for use with the engine 2101 that allows fuel to be injected into the transfer passages during cold starts, idling, or acceleration. The intake system 2220 is formed as a split passage 2221A, 2221B connected to the engine 2101. The passage 2221B branches into the secondary passage 2129. As seen in FIGS. 48-49, the secondary passage 2129 wraps around the engine 2101 and is connected to transfer passages 2130 of the engine 2101. The passage 2221A is connected directly to the inlet port 2128 formed in the wall 2118 of the cylinder 2102. The intake system also includes a throttle valve 2223 and an air filter 2222. The throttle valve 2223 may be a butterfly type control valve, although other types of valves may also be used.

The throttle valve 2223 may be set to a part throttle position, as shown in FIG. 51B, where an air stream flows under the throttle valve 2223 and is split into two separate streams. The primary stream goes directly into the crankcase chamber 2103 and the secondary stream flows into the transfer passages 2130 through the passage 2129. As seen in FIG. 51B, approximately 25-50% of the air stream flows into the transfer passages 2130, while the remaining 50-75% of the air stream flows directly into the crankcase chamber 2103. However, other fractions may also be used based on the throttle valve 2223 setting and the configuration of passages 2221A, and 2221B.

As seen in FIG. 51B, the position of the fuel injector 2224 allows fuel to be injected into both passages 2221A and 2221B. Alternately, the fuel injector 2224 may be positioned within passage 2221B. As shown the tip of the injector may be flush with the inner wall of the passage 2221A and positioned in such a way that part of the fuel may flow into the secondary passage 2129 at least when the throttle valve 2223 is partly open. With a pulse controlled injection system as described above, it is possible to supply fuel into only the crankcase through passage 2221A by delaying the start of injection. The level of purity of the air flowing through the passage 2221B and into the transfer passages 2130 is determined by the start of injection with respect to the throttle position. As the piston 2104 ascends, the exhaust port 2116 and transfer ports 2132 are closed by the piston 2104, and the pressure in the crankcase 2103 drops, thereby allowing air to flow into the transfer passages 2130 through the passage 2129. Substantially all of the air flows through passage 2129 until the main inlet port 2128 is opened by the piston 2104. Therefore, if fuel injection starts early during the induction process, fuel flows through the passage 2129 and reduces the purity of the air in the transfer passage 2130. Once the main inlet port 2128 is opened by the piston 2104, the flow of air through the passage 2129 is reduced. By delaying the start of injection under certain operating conditions, it is possible to inject fuel into the air stream flowing directly into the crankcase 2103. In addition, with the use of a crank web as a rotary valve as described above, it is possible to completely shut off the induction of air into the transfer passage 2130 after a predetermined crank angle during the induction process. Therefore, the start of injection and the throttle position determine the level of stratification during scavenging operations.

During idling and acceleration, stratification may still be achieved as described above for engine 2101. However, during wide open throttle (WOT) conditions, fuel is injected only into the air flowing into the crankcase 2103. As described above, this substantially pure air in the transfer passage 2130 allows for full stratification during the scavenging process and lowers the emissions at steady state operating conditions. However, because trapping efficiency is lower when the engine runs at lower speeds, it is also desired to maintain stratification for lower emissions at lower speeds. Therefore, the fuel injection timing may be tailored to optimize the trapping of fuel and the reduction of emissions at all operating speed ranges.

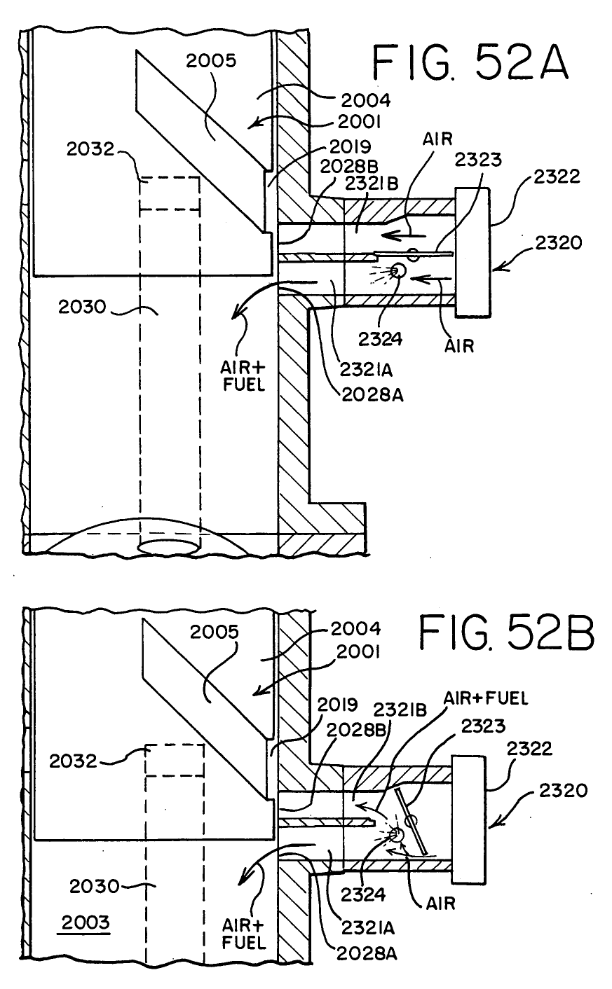

Similarly, FIGS. 52A-52B illustrate an alternate intake system 2320 for use with the engine 2001 that allows fuel to be injected into the transfer passages 2030 during cold starts, idling, or acceleration. The intake system 2320 is also formed as a split passage 2321A, 2321B connected to the engine 2001. Both passages 2321A, 2321B are connected directly to the inlet ports 2028A, 2028B formed in the wall 2018 of the cylinder 2002. Near TDC, as the piston 2004 rises within the cylinder 2002, the channel 2005 aligns with the upper passage 2321B, while the lower passage 2321A is directly connected to the crankcase 2003. As described above for intake system 2220, the primary stream of air goes directly into the crankcase 2003 while the secondary stream flows into the transfer passages 2030 through the channel 2005. Other aspects of intake system 2320 are similar to the intake system 2220 shown in FIGS. 51A-51B and described above.

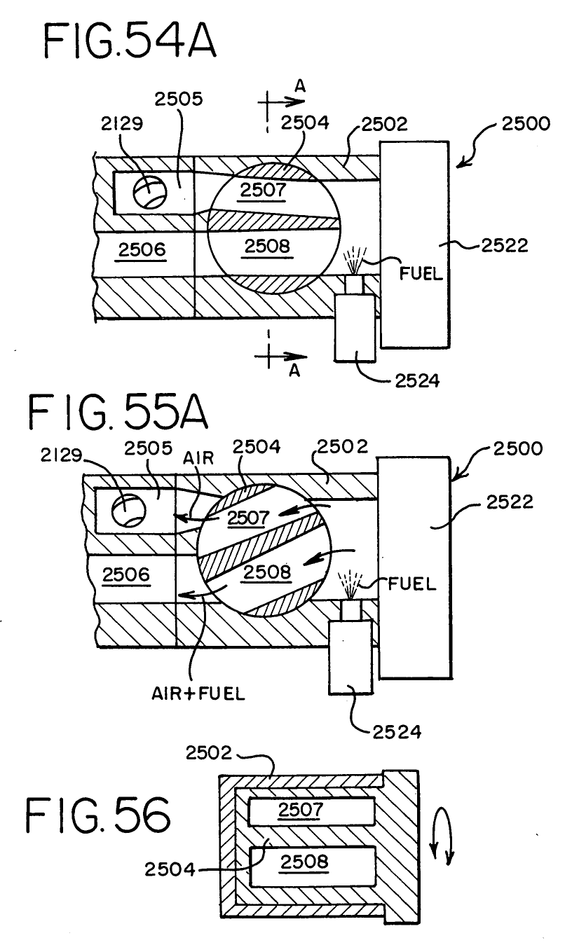

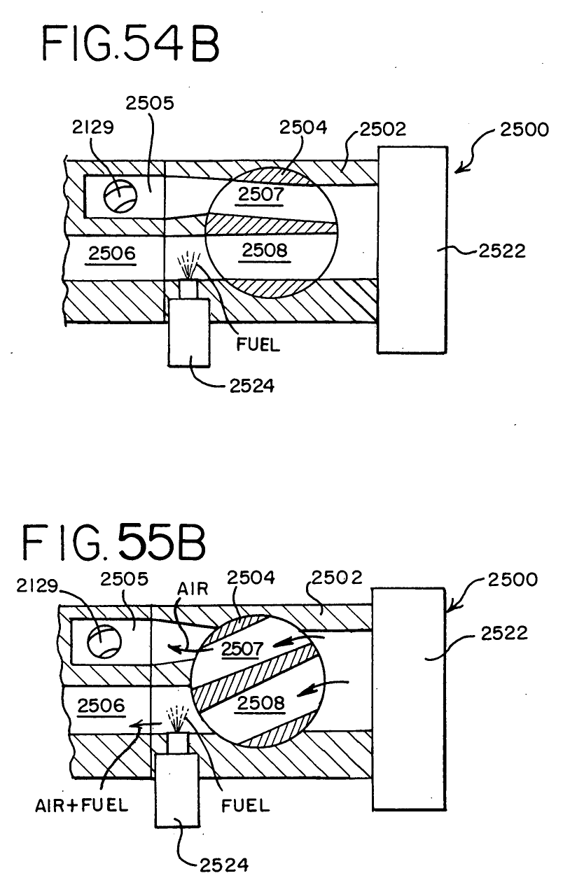

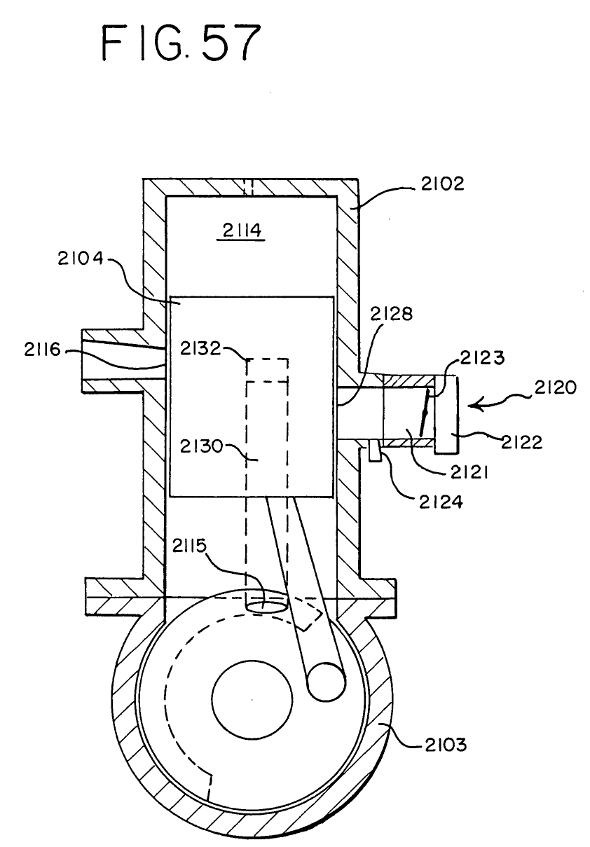

FIGS. 54A-56 illustrate an alternate throttle 2500 that may be used with intake systems 2220 and 2320. The throttle 2500 includes a throttle body 2502, a throttle valve 2504, an air filter 2522, and a fuel injector 2524. The tip of the fuel injector 2524 is shown to be flush with the intake passage. The injector 2524 may also be located on the down stream side of the throttle valve 2504 closer to the passage 2506 as shown in FIGS. 54B and 55B. The throttle body 2502 has two interior passages 2505, 2506 extending through the throttle 2502. As seen in FIGS. 54A-55B, both passages 2505 and 2506 are connected to the air filter at one end. At the other end, passage 2505 may be connected to the secondary passage 2129, while passage 2506 may be connected to the inlet port 2128. Alternately, both passages 2505, 2506 may be connected directly to the inlet port 2128 for a piston-ported engine 2001 as described above and shown in FIGS. 44-47.

The throttle valve 2504 is rotatably mounted within throttle body 2502 and has two passages 2507 and 2508. For a throttle open position as shown in FIG. 54, passage 2507 flows to passage 2505, while passage 2508 flows to passage 2506. As the throttle valve 2504 is rotated, the passages 2507, 2508 are rotated, thereby restricting air and fuel flow to passages 2505 and 2506. The throttle valve 2504 may be a barrel type control valve, although other types of valves may also be used. Other aspects of throttle 2500 are similar to the intake systems 2120 and 2220 shown in FIGS. 51A-52B and described above.

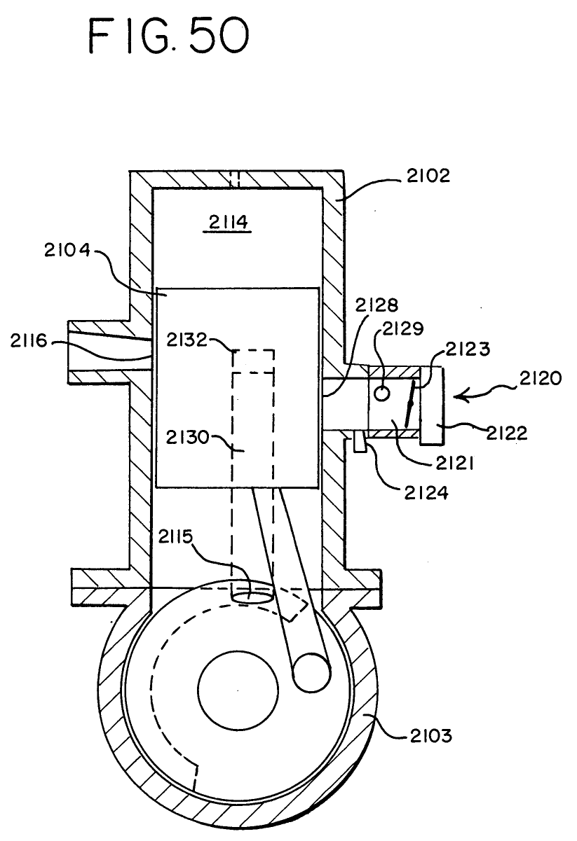

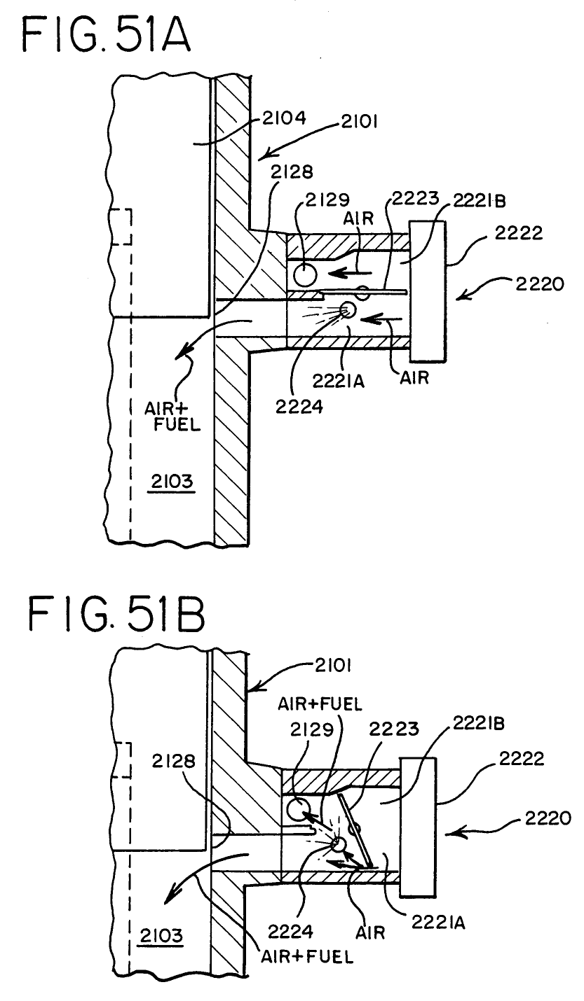

Another embodiment of a two-stroke engine is illustrated in FIG. 57. The two-stroke engine shown in FIG. 57 is similar in some respects to the two-stroke engine shown in FIG. 50. Therefore, the same numbering is used for corresponding components. However, in contrast to FIG. 50, the two-stroke engine shown in FIG. 57 is a conventional two-stroke engine without stratification as described above. That is, there is no passage or channel for air to flow directly from the intake system 2120 to the transfer passage 2130. Thus, substantially all of the air-fuel mixture flows from the intake passage 2121 through the inlet port 2128 into the crankcase 2103 when the piston 2104 is at least partly above the inlet port 2128. The air-fuel mixture then flows through the lower transfer passage port 2115 into the transfer passage 2130. From there, the air-fuel mixture flows through the transfer port 2132 into the combustion chamber 2114. An injection system, such as the example shown in FIG. 39 may be incorporated into the conventional two-stroke engine shown in FIG. 57. In addition, as described above, a low pressure injector may be incorporated into the two-stroke engine, such as the injectors shown in FIGS. 41 and 42.

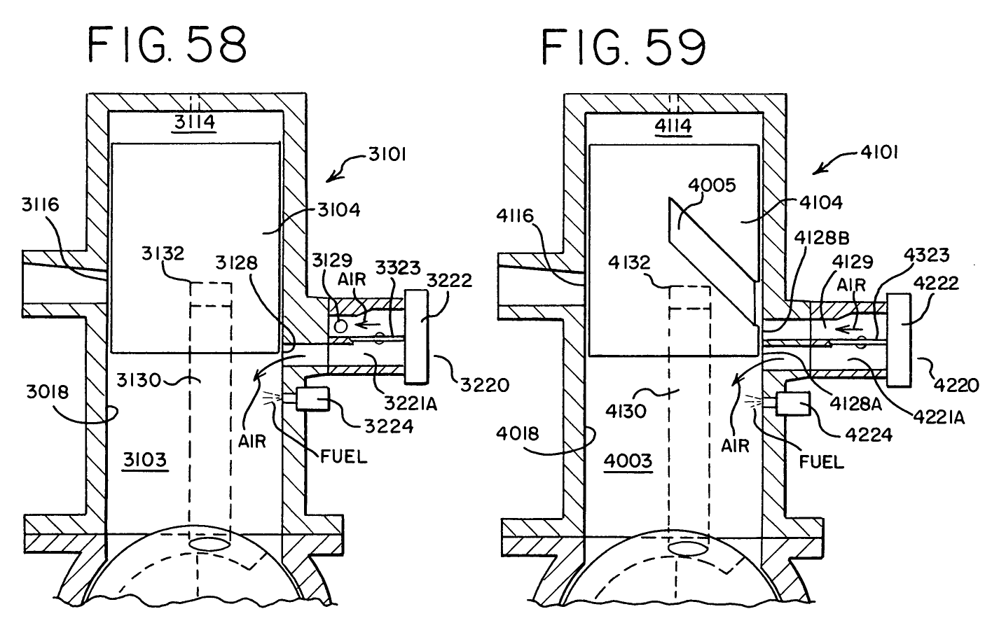

FIGS. 58 and 59 illustrate additional embodiments of a two-stroke engine 3101, 4101. Since the features of the engines 3101, 4101 in FIGS. 58 and 59 are similar in certain aspects to the engines described above, it is unnecessary to repeat the description of every feature. For convenience, the numbering sequences used to denote the engine features generally correspond to the numbering sequences used above. In FIG. 58 the numbering sequence uses 3000 series numbers, and in FIG. 59 the numbering sequence uses 4000 series numbers. As shown in FIGS. 58 and 59, the fuel injector 3224, 4224 may be positioned in the crankcase 3103, 4003. Thus, the fuel injector 3224, 4224 supplies fuel to the air which flows into the crankcase 3103, 4003. In FIGS. 58 and 59, the intake system 3220, 4220 supplies two streams of air to the engine 3101, 4101. As described above, one steam of air is supplied to the transfer passage 3130, 4130. In FIG. 58, this stream of air travels through a passage 3129 to the transfer passage 3130. The top sectional view would be similar to FIG. 48, except that the injector 2124 in FIG. 48 is on the cylinder wall 3018 in FIG. 58. In FIG. 59, the stream of air travels through a channel 4005 in the piston 4104. Alternatively, a fuel injector may be positioned in the crankcase as shown in FIGS. 21 and 28 where all of the air from the intake system travels to the transfer passage.

As also shown in FIGS. 58 and 59, the fuel injector 3224, 4224 may be positioned along the cylinder wall 3018, 4018. This is also shown in FIGS. 16A and 17A where all of the air from the intake system travels to the transfer passage. A fuel injector could also be positioned along the cylinder wall of the engine shown in FIG. 57 where all of the air from the intake system travels to the crankcase. Preferably, the fuel injector 3224, 4224 is positioned so that the fuel injector 3224, 4224 is only exposed to the crankcase 3103, 4003 when the piston 3104, 4104 is within 140° from top dead center. The fuel injector 3224, 4224 is exposed to low pressure in the crankcase 3103, 4003 when the piston 3104, 4104 travels upward to the top dead center position while air is inducted into the crankcase 3103, 4003. As the piston 3104, 4104 travels upward, the hole, or tip of the injector, through which fuel is injected into the crankcase 3103, 4003 is uncovered by the piston 3104, 4104. At this stage, the crankcase pressure is lower. Thus, the fuel injection may be relatively low pressure, e.g., 1 to 10 psi. As the piston 3104, 4104 descends toward bottom dead center, the crankcase pressure increases. The crankcase pressure is typically highest just before the transfer port opens, and in some cases, the blow down from combustion chamber into the transfer passage and into crankcase can cause the crankcase pressure to be even higher. However, by covering the injector hole as the piston 3104, 4104 descends, the fuel injector 3224, 4224 is protected from high pressure in the crankcase 3103, 4003. This ensures that the fuel injector 3224, 4224 experiences only low pressure while exposed to the crankcase 3103, 4003 while the piston 3104, 4104 is near top dead center. The fuel injector 3224, 4224 may also be positioned so that it is never directly exposed to the combustion chamber 3114, 4114. Again, this minimizes exposure of the fuel injector 3224, 4224 to high pressures. By locating the fuel injector 3224, 4224 along the cylinder wall 3018, 4018 to minimize exposure to high pressures, the fuel injector 3224, 4224 may be especially well-suited to using a low pressure fuel supply. Thus, a low pressure pump as described above may be used. In addition, the fuel injector 3224, 4224 may be positioned so that it is adjacent a channel or cavity in the piston during part of the piston's reciprocation. Thus, the fuel injector 3224, 4224 may supply fuel to the channel during certain operating conditions. This is shown in FIG. 16A. This may be desirable, for example, at idle, acceleration, and during cold starting.

It will be appreciated that the above illustrated and described two-stroke engine provides a novel air and fuel intake configuration which may be used for improved scavenging and stratification. The two-stroke engine is particularly well suited for driving a flexible line trimmer for cutting vegetation, but it may also be used for a brush cutter having a rigid blade or a lawn edger. The engine may also be used for driving a hedge trimmer, vacuum, blower, snow blower, power hacksaw, circular saw, chain saw, water pump, lawn mower, or generator, for example.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

We claim:

1. A two-stroke internal combustion engine, comprising:
a piston, a combustion chamber and a crankcase;
a transfer passage comprising a transfer port in gaseous communication with said combustion chamber at least a portion of time said piston is below top dead center; and
an intake system in gaseous communication with ambient, said intake system supplying a first stream of air to said transfer passage at least a portion of time said piston is between top dead center and bottom dead center; said intake system further supplying a second stream of air to said crankcase at least a portion of time said piston is above bottom dead center.

2. The two-stroke internal combustion engine of claim 1, wherein said transfer passage is in gaseous communication with said crankcase.

3. The two-stroke internal combustion engine of claim 2, further comprising a crank web opening and closing said transfer passage within said crankcase as said crank web rotates.

4. The two-stroke internal combustion engine of claim 1, wherein said intake system further comprises a fuel injector, said fuel injector supplying fuel only to said second stream of air.

5. The two-stroke internal combustion engine of claim 1, wherein said intake system further comprises a body, a throttle valve disposed therein and regulating air flow therethrough, and a fuel injector supplying fuel to said air flow.

6. The two-stroke internal combustion engine of claim 5, wherein said fuel injector is disposed upstream from said throttle valve.

7. The two-stroke internal combustion engine of claim 5, wherein said fuel injector is disposed downstream from said throttle valve.

8. The two-stroke internal combustion engine of claim 1, wherein said intake system further comprises a fuel injector, said fuel injector supplying fuel to both said first stream of air and said second stream of air during at least one operating condition.

9. The two-stroke internal combustion engine of claim 8, wherein said intake system further comprises a throttle valve regulating air flow through said intake system and a fuel injector, said fuel injector supplying fuel only to said second stream of air when said throttle valve is 75% to 100% open.

10. The two-stroke internal combustion engine of claim 1, wherein said piston comprises a channel in gaseous communication with said intake system and in gaseous communication with said transfer passage at least a portion of time said piston is between top dead center and bottom dead center, said channel thereby supplying said first stream of air from said intake system to said transfer passage, at least a portion of said first stream supplied through said channel being substantially pure without fuel mixed therein.

11. The two-stroke internal combustion engine of claim 1, further comprising a passage in gaseous communication with said intake system and said transfer passage, said passage branching from said intake system and wrapping around at least a portion of the engine, said passage thereby supplying said first stream of air from said intake system to said transfer passage.

12. The two-stroke internal combustion engine of claim 1, wherein said transfer passage is in gaseous communication with said crankcase and further comprising a reed valve disposed between said intake system and said transfer passage, said reed valve opening to supply said first steam of air to said transfer passage at least a portion of time said piston rises from bottom dead center to top dead center.

13. The two-stroke internal combustion engine of claim 1, wherein said intake system further comprises a first passage, a second passage and a throttle valve regulating air flow through said intake system, said throttle valve supplying air to both said first passage and said second passage, said first passage and said second passage separating said air flow from said throttle valve into said first stream of air and said second stream of air, said first passage supplying said first stream of air to said transfer passage and said second passage supplying said second stream of air to said crankcase.

14. The two-stroke internal combustion engine of claim 13, wherein said intake system further comprises a fuel injector supplying fuel to said air flow, said fuel injector being disposed upstream of said first passage and said second passage.

15. The two-stroke internal combustion engine of claim 1, wherein said intake system further comprises a fuel injector, said fuel injector supplying fuel to air flowing through a passage of said intake system, a tip of said fuel injector being flush with said passage.

16. The two-stroke internal combustion engine of claim 1, wherein said intake system further comprises a throttle valve regulating air flow through said intake system, said throttle valve comprising a first passage and a second passage, said intake system further comprising a third passage in gaseous communication with said first passage and supplying said first stream of air to said transfer passage and a fourth passage in gaseous communication with said second passage and supplying said second stream of air to said crankcase, said first passage and said second passage separating said air flow into said first stream of air and said second stream of air.

17. The two-stroke internal combustion engine of claim 16, wherein said intake system further comprises a fuel injector disposed within said fourth passage, said fuel injector thereby supplying fuel only to said second stream of air.

18. The two-stroke internal combustion engine of claim 1, wherein said intake system further comprises a single passage with a throttle valve disposed therein and regulating air flow through said passage to a single inlet port disposed along a cylinder wall of said combustion chamber, wherein said second stream of air flows to said crankcase through said inlet port when said piston is above at least a portion of said inlet port.

19. The two-stroke internal combustion engine of claim 18, wherein said piston comprises a channel in gaseous communication with said inlet port and in gaseous communication with said transfer passage at least a portion of time said piston is between top dead center and bottom dead center, said channel thereby supplying said first stream of air from said intake system to said transfer passage.

20. The two-stroke internal combustion engine of claim 1, wherein said intake system further comprises a throttle valve regulating air flow through said intake system and a fuel injector supplying fuel to said air flow, said fuel injector being disposed upstream from said throttle valve.

21. The two-stroke internal combustion engine of claim 1, wherein said intake system further comprises a throttle valve regulating air flow through said intake system and a fuel injector supplying fuel to said air flow, said fuel injector being disposed downstream from said throttle valve.

22. The two-stroke internal combustion engine of claim 1, further comprising at least two of said transfer passages, said intake system supplying at least a portion of said first stream of air to each of said transfer passages.

23. The two-stroke internal combustion engine of claim 1, further comprising a fuel injector disposed in said crankcase and supplying fuel to said crankcase.

24. The two-stroke internal combustion engine of claim 1, wherein said transfer passage is in gaseous communication with said crankcase, and said piston comprises a channel in gaseous communication with said intake system and in gaseous communication with said transfer passage at least a portion of time said piston is between top dead center and bottom dead center, said channel thereby supplying said first stream of air from said intake system to said transfer passage, at least a portion of said first stream supplied through said channel being substantially pure without fuel mixed therein.

25. The two-stroke internal combustion engine of claim 24, further comprising a crank web opening and closing said transfer passage within said crankcase as said crank web rotates.

26. The two-stroke internal combustion engine of claim 25, wherein said intake system further comprises a fuel injector, said fuel injector supplying fuel to both said first stream of air and said second stream of air during at least one operating condition.

27. The two-stroke internal combustion engine of claim 26, wherein said intake system further comprises a first passage, a second passage and a throttle valve regulating air flow through said intake system, said throttle valve supplying air to both said first passage and said second passage, said first passage and said second passage separating said air flow from said throttle valve into said first stream of air and said second stream of air, said first passage supplying said first stream of air to said transfer passage and said second passage supplying said second stream of air to said crankcase, said fuel injector being disposed upstream of said first passage and said second passage.

28. The two-stroke internal combustion engine of claim 26, wherein said intake system further comprises a throttle valve regulating air flow through said intake system, said throttle valve comprising a first passage and a second passage, said intake system further comprising a third passage in gaseous communication with said first passage and supplying said first stream of air to said transfer passage and a fourth passage in gaseous communication with said second passage and supplying said second stream of air to said crankcase, said first passage and said second passage separating said air flow into said first stream of air and said second stream of air, said fuel injector being disposed upstream from said throttle valve.

29. The two-stroke internal combustion engine of claim 25, further comprising a fuel injector, said fuel injector supplying fuel only to said second stream of air.

30. The two-stroke internal combustion engine of claim 29, wherein said intake system further comprises a first passage, a second passage and a throttle valve regulating air flow through said intake system, said throttle valve supplying air to both said first passage and said second passage, said first passage and said second passage separating said air flow from said throttle valve into said first stream of air and said second stream of air, said first passage supplying said first stream of air to said transfer passage and said second passage supplying said second stream of air to said crankcase, said fuel injector being disposed within said second passage.

31. The two-stroke internal combustion engine of claim 29, wherein said intake system further comprises a throttle valve regulating air flow through said intake system, said throttle valve comprising a first passage and a second passage, said intake system further comprising a third passage in gaseous communication with said first passage and supplying said first stream of air to said transfer passage and a fourth passage in gaseous communication with said second passage and supplying said second stream of air to said crankcase, said first passage and said second passage separating said air flow into said first stream of air and said second stream of air, said fuel injector being disposed within said fourth passage.

32. The two-stroke internal combustion engine of claim 1, wherein said transfer passage is in gaseous communication with said crankcase, further comprising a passage in gaseous communication with said intake system and said transfer passage, said passage branching from said intake system and wrapping around at least a portion of the engine, said passage thereby supplying said first stream of air from said intake system to said transfer passage, and a reed valve disposed between said intake system and said transfer passage, said reed valve opening to supply said first steam of air through said passage to said transfer passage at least a portion of time said piston rises from bottom dead center to top dead center.

33. The two-stroke internal combustion engine of claim 32, further comprising a crank web opening and closing said transfer passage within said crankcase as said crank web rotates.

34. The two-stroke internal combustion engine of claim 33, wherein said intake system further comprises a fuel injector, said fuel injector supplying fuel to both said first stream of air and said second stream of air during at least one operating condition.

35. The two-stroke internal combustion engine of claim 34, wherein said intake system further comprises a first passage, a second passage and a throttle valve regulating air flow through said intake system, said throttle valve supplying air to both said first passage and said second passage, said first passage and said second passage separating said air flow from said throttle valve into said first stream of air and said second stream of air, said first passage supplying said first stream of air to said transfer passage and said second passage supplying said second stream of air to said crankcase, said fuel injector being disposed upstream of said first passage and said second passage.

36. The two-stroke internal combustion engine of claim 34, wherein said intake system further comprises a throttle valve regulating air flow through said intake system, said throttle valve comprising a first passage and a second passage, said intake system further comprising a third passage in gaseous communication with said first passage and supplying said first stream of air to said transfer passage and a fourth passage in gaseous communication with said second passage and supplying said second stream of air to said crankcase, said first passage and said second passage separating said air flow into said first stream of air and said second stream of air, said fuel injector being disposed upstream from said throttle valve.

37. The two-stroke internal combustion engine of claim 33, further comprising a fuel injector, said fuel injector supplying fuel only to said second stream of air.

38. The two-stroke internal combustion engine of claim 37, wherein said intake system further comprises a first passage, a second passage and a throttle valve regulating air flow through said intake system, said throttle valve supplying air to both said first passage and said second passage, said first passage and said second passage separating said air flow from said throttle valve into said first stream of air and said second stream of air, said first passage supplying said first stream of air to said transfer passage and said second passage supplying said second stream of air to said crankcase, said fuel injector being disposed within said second passage.

39. The two-stroke internal combustion engine of claim 37, wherein said intake system further comprises a throttle valve regulating air flow through said intake system, said throttle valve comprising a first passage and a second passage, said intake system further comprising a third passage in gaseous communication with said first passage and supplying said first stream of air to said transfer passage and a fourth passage in gaseous communication with said second passage and supplying said second stream of air to said crankcase, said first passage and said second passage separating said air flow into said first stream of air and said second stream of air, said fuel injector being disposed within said fourth passage.

40. The two-stroke internal combustion engine of claim 1, wherein said fuel injector supplies fuel during steady state operation in a first injection starting at least 5° after said second stream of air begins to be inducted into said crankcase and ending no later than 20° after top dead center.

41. The two-stroke internal combustion engine of claim 40, wherein said first injection further starts after said first stream of air stops being inducted into said transfer passage.

42. The two-stroke internal combustion engine of claim 41, wherein said fuel injector supplies fuel during acceleration in a second injection starting no more than 15° before said first stream of air begins to be inducted into said transfer passage.

43. The two-stroke internal combustion engine of claim 42, wherein said fuel injector supplies fuel during idle in a third injection starting after said second injection starts during acceleration and ending before said second injection ends during acceleration.

44. The two-stroke internal combustion engine of claim 43, further comprising a crank web opening and closing said transfer passage within said crankcase as said crank web rotates.

45. The two-stroke internal combustion engine of claim 1, further comprising a fuel injector disposed along a cylinder wall through which said piston reciprocates.

46. The two-stroke internal combustion engine of claim 45, further comprising a low pressure pump supplying fuel to said fuel injector, said low pressure pump pressurizing said fuel to 1 to 10 psig.

47. The two-stroke internal combustion engine of claim 46, wherein said fuel injector is only exposed to said crankcase during a portion of time said piston is within 140° from top dead center.

48. The two-stroke internal combustion engine of claim 47, wherein said fuel injector is not exposed to said combustion chamber at any time during reciprocation of said piston.

49. The two-stroke internal combustion engine of claim 45, wherein said piston comprises a channel, said fuel injector supplying fuel to said channel during a time said channel is adjacent said fuel injector.

50. The two-stroke internal combustion engine of claim 45, further comprising a low pressure pump supplying fuel to said fuel injector, said low pressure pump pressurizing said fuel to 1 to 10 psig, wherein said fuel injector is only exposed to said crankcase during a portion of time said piston is within 140° from top dead center.

51. The two-stroke internal combustion engine of claim 50, wherein said piston comprises a channel, said fuel injector supplying fuel to said channel during a time said channel is adjacent said fuel injector.

52. The two-stroke internal combustion engine of claim 1, further comprising one of said transfer passages on one side of said intake system and another of said transfer passages on an opposite side of said intake system, said intake system supplying said first stream of air to both of said transfer passages.

53. The two-stroke internal combustion engine of claim 52, wherein said intake system further comprises one inlet port supplying said first stream of air to said one transfer passage and another inlet port supplying said first stream of air to said another transfer passage.

54. The two-stroke internal combustion engine of claim 52, wherein said piston comprises a channel in gaseous communication with said intake system and in gaseous communication with both of said transfer passages at least a portion of time said piston is between top dead center and bottom dead center, said channel thereby supplying said first stream of air from said intake system to both of said transfer passages.

55. The two-stroke internal combustion engine of claim 52, wherein said piston comprises one channel in gaseous communication with said intake system and in gaseous communication with said one transfer passage at least a portion of time said piston is between top dead center and bottom dead center and another channel in gaseous communication with said intake system and in gaseous communication with said another transfer passage at least a portion of time said piston is between top dead center and bottom dead center, said one channel and said another channel thereby supplying said first stream of air from said intake system to both of said transfer passages.

56. The two-stroke internal combustion engine of claim 55, wherein said intake system further comprises one inlet port supplying said first stream of air to said one channel and another inlet port supplying said first stream of air to said another channel.

57. A two-stroke internal combustion engine, comprising:
a piston, a combustion chamber and a crankcase;
a transfer passage in gaseous communication with said crankcase and comprising a transfer port in gaseous communication with said combustion chamber at least a portion of time said piston is below top dead center; and
an intake system in gaseous communication with ambient, said intake system supplying a stream of air to said transfer passage at least a portion of time said piston is between top dead center and bottom dead center.

58. The two-stroke internal combustion engine of claim 57, wherein said stream of air comprises substantially all air flow through said intake system.

59. The two-stroke internal combustion engine of claim 58, further comprising a fuel injector disposed in said crankcase and supplying fuel to said crankcase.

60. The two-stroke internal combustion engine of claim 59, wherein said intake system further comprises a fuel injector, said fuel injector being disposed adjacent said transfer passage and supplying fuel only to said stream of air.

61. The two-stroke internal combustion engine of claim 60, wherein said fuel injector supplies fuel to said stream of air during steady state operation in a first injection starting at least 5° after said stream of air begins to be inducted into said transfer passage and ending no later than 50 before top dead center.

62. The two-stroke internal combustion engine of claim 61, wherein said fuel injector supplies fuel to said stream of air during acceleration in a second injection and a third injection, said second injection supplying fuel during at least a portion of time said stream of air is inducted into said combustion chamber.

63. The two-stroke internal combustion engine of claim 62, wherein said third injection starts before said first injection starts during steady state operation and ends after said first injection ends during steady state operation, said third injection supplying more fuel to said stream of air than said second injection.

64. The two-stroke internal combustion engine of claim 63, wherein said fuel injector supplies fuel to said stream of air during idle in a fourth injection starting after said stream of air begins to be inducted into said transfer passage and ending before top dead center.

65. The two-stroke internal combustion engine of claim 64, further comprising a crank web opening and closing said transfer passage within said crankcase as said crank web rotates.

66. The two-stroke internal combustion engine of claim 58, further comprising a fuel injector disposed along a cylinder wall through which said piston reciprocates.

67. The two-stroke internal combustion engine of claim 66, further comprising a low pressure pump supplying fuel to said fuel injector, said low pressure pump pressurizing said fuel to 1 to 10 psig.

68. The two-stroke internal combustion engine of claim 66, wherein said fuel injector is only exposed to said crankcase during a portion of time said piston is within 140° from top dead center.

69. The two-stroke internal combustion engine of claim 68, wherein said fuel injector is not exposed to said combustion chamber at any time during reciprocation of said piston.

70. The two-stroke internal combustion engine of claim 66, wherein said piston comprises a channel, said fuel injector supplying fuel to said channel during a time said channel is adjacent said fuel injector.

71. The two-stroke internal combustion engine of claim 66, further comprising a low pressure pump supplying fuel to said fuel injector, said low pressure pump pressurizing said fuel to 1 to 10 psig, wherein said fuel injector is only exposed to said crankcase during a portion of time said piston is within 140° from top dead center.

72. The two-stroke internal combustion engine of claim 71, wherein said piston comprises a channel, said fuel injector supplying fuel to said channel during a time said channel is adjacent said fuel injector.

73. The two-stroke internal combustion engine of claim 58, further comprising one of said transfer passages on one side of said intake system and another of said transfer passages on an opposite side of said intake system, said intake system supplying said stream of air to both of said transfer passages.

74. The two-stroke internal combustion engine of claim 73, wherein said intake system further comprises one inlet port supplying said stream of air to said one transfer passage and another inlet port supplying said first stream of air to said another transfer passage.

75. The two-stroke internal combustion engine of claim 73, wherein said piston comprises a channel in gaseous communication with said intake system and in gaseous communication with both of said transfer passages at least a portion of time said piston is between top dead center and bottom dead center, said channel thereby supplying said stream of air from said intake system to both of said transfer passages.

76. The two-stroke internal combustion engine of claim 73, wherein said piston comprises one channel in gaseous communication with said intake system and in gaseous communication with said one transfer passage at least a portion of time said piston is between top dead center and bottom dead center and another channel in gaseous communication with said intake system and in gaseous communication with said another transfer passage at least a portion of time said piston is between top dead center and bottom dead center, said one channel and said another channel thereby supplying said stream of air from said intake system to both of said transfer passages.

77. The two-stroke internal combustion engine of claim 76, wherein said intake system further comprises one inlet port supplying said stream of air to said one channel and another inlet port supplying said stream of air to said another channel.

78. A hand-held power tool, comprising:
an operating head adapted to perform desired work;
a two-stroke engine operably connected to said operating head, a crankshaft of the two-stroke engine driving said operating head, the two-stroke engine comprising a fuel injector supplying fuel thereto and a low pressure pump supplying fuel to said fuel injector, said low pressure pump pressurizing said fuel to 1 to 10 psig; and
at least one handle adapted to be engaged by an operator to manually lift the operating head and the two-stroke engine.

79. The hand-held power tool of claim 78, wherein said operating head comprises a flexible line trimmer.

80. The hand-held power tool of claim 78, further comprising a diaphragm pump supplying fuel to said fuel injector, said diaphragm pump pumping the fuel in response to changes in pressure in a crankcase of the engine.

81. The hand-held power tool of claim 80, further comprising a pressure regulator limiting a pressure of fuel supplied to said fuel injector.

82. The hand-held power tool of claim 81, wherein said fuel injector comprises an electromagnetic coil adapted to open and close communication between a fuel inlet to said fuel injector and an outlet of said fuel injector, said electromagnetic coil being responsive to an electronic control unit, and a spring biasing a plunger to close communication between said fuel inlet and said outlet.

83. The hand-held power tool of claim 78, wherein said two-stroke engine comprises a transfer passage comprising a transfer port in gaseous communication with a combustion chamber at least a portion of time a piston is below top dead center, and an intake system in gaseous communication with ambient, said intake system supplying a first stream of air to said transfer passage at least a portion of time said piston is between top dead center and bottom dead center, and said intake system further supplying a second stream of air to a crankcase at least a portion of time said piston is above bottom dead center.

84. The hand-held power tool of claim 83, further comprising a diaphragm pump supplying fuel to said fuel injector, said diaphragm pump pumping the fuel in response to changes in pressure in said crankcase, a pressure regulator limiting a pressure of fuel supplied to said fuel injector, and wherein said fuel injector comprises an electromagnetic coil adapted to open and close communication between a fuel inlet to said fuel injector and an outlet of said fuel injector, said electro-magnetic coil being responsive to an electronic control unit, and a spring biasing a plunger to close communication between said fuel inlet and said outlet.

85. The hand-held power tool of claim 78, wherein said two-stroke engine comprises a transfer passage in gaseous communication with a crankcase and comprising a transfer port in gaseous communication with a combustion chamber at least a portion of time said piston is below top dead center, and an intake system in gaseous communication with ambient, said intake system supplying a stream of air comprising substantially all air flow through said intake system to said crankcase, whereby said stream of air flows through said transfer passage to said combustion chamber.

86. The hand-held power tool of claim 85, further comprising a diaphragm pump supplying fuel to said fuel injector, said diaphragm pump pumping the fuel in response to changes in pressure in said crankcase, a pressure regulator limiting a pressure of fuel supplied to said fuel injector, and wherein said fuel injector comprises an electromagnetic coil adapted to open and close communication between a fuel inlet to said fuel injector and an outlet of said fuel injector, said electromagnetic coil being responsive to an electronic control unit, and a spring biasing a plunger to close communication between said fuel inlet and said outlet.

87. The hand-held power tool of claim 78, wherein said two-stroke engine comprises a transfer passage in gaseous communication with a crankcase and comprising a transfer port in gaseous communication with a combustion chamber at least a portion of time said piston is below top dead center, and an intake system in gaseous communication with ambient, said intake system supplying a stream of air comprising substantially all air flow through said intake system to said transfer passage.

88. The hand-held power tool of claim 87, further comprising a diaphragm pump supplying fuel to said fuel injector, said diaphragm pump pumping the fuel in response to changes in pressure in said crankcase, a pressure regulator limiting a pressure of fuel supplied to said fuel injector, and wherein said fuel injector comprises an electro-magnetic coil adapted to open and close communication between a fuel inlet to said fuel injector and an outlet of said fuel injector, said electromagnetic coil being responsive to an electronic control unit, and a spring biasing a plunger to close communication between said fuel inlet and said outlet.

89. A two-stroke internal combustion engine, comprising:
a crankcase, a combustion chamber, a piston and a cylinder wall, said piston reciprocating within said cylinder wall;
a transfer passage in gaseous communication with said crankcase and comprising a transfer port in gaseous communication with said combustion chamber at least a portion of time said piston is below top dead center;
an intake system in gaseous communication with ambient operable to supply air to said combustion chamber; and
a fuel injector disposed along said cylinder wall.

90. The two-stroke internal combustion engine of claim 89, further comprising a low pressure pump supplying fuel to said fuel injector, said low pressure pump pressurizing said fuel to 1 to 10 psig.

91. The two-stroke internal combustion engine of claim 89, wherein said fuel injector is only exposed to said crankcase during a portion of time said piston is within 1400 from top dead center.

92. The two-stroke internal combustion engine of claim 91, wherein said fuel injector is not exposed to said combustion chamber at any time during reciprocation of said piston.

93. The two-stroke internal combustion engine of claim 89, wherein said piston comprises a channel, said fuel injector supplying fuel to said channel during a time said channel is adjacent said fuel injector.

94. The two-stroke internal combustion engine of claim 89, further comprising a low pressure pump supplying fuel to said fuel injector, said low pressure pump pressurizing said fuel to 1 to 10 psig, wherein said fuel injector is only exposed to said crankcase during a portion of time said piston is within 140° from top dead center.

95. The two-stroke internal combustion engine of claim 94, wherein said piston comprises a channel, said fuel injector supplying fuel to said channel during a time said channel is adjacent said fuel injector.

96. The two-stroke internal combustion engine of claim 94, wherein said intake system supplies a first stream of air to said transfer passage at least a portion of time said piston is between top dead center and bottom dead center and supplies a second stream of air to said crankcase at least a portion of time said piston is above bottom dead center.

97. The two-stroke internal combustion engine of claim 96, further comprising a diaphragm pump supplying fuel to said fuel injector, said diaphragm pump pumping the fuel in response to changes in pressure in said crankcase, a pressure regulator limiting a pressure of fuel supplied to said fuel injector, and wherein said fuel injector comprises an electro-magnetic coil adapted to open and close communication between a fuel inlet to said fuel injector and an outlet of said fuel injector, said electro-magnetic coil being responsive to an electronic control unit, and a spring biasing a plunger to close communication between said fuel inlet and said outlet.

98. The two-stroke internal combustion engine of claim 94, wherein said intake system supplies a stream of air comprising substantially all air flow through said intake system to said crankcase, whereby said stream of air flows through said transfer passage to said combustion chamber.

99. The two-stroke internal combustion engine of claim 98, further comprising a diaphragm pump supplying fuel to said fuel injector, said diaphragm pump pumping the fuel in response to changes in pressure in said crankcase, a pressure regulator limiting a pressure of fuel supplied to said fuel injector, and wherein said fuel injector comprises an electro-magnetic coil adapted to open and close communication between a fuel inlet to said fuel injector and an outlet of said fuel injector, said electro-magnetic coil being responsive to an electronic control unit, and a spring biasing a plunger to close communication between said fuel inlet and said outlet.

100. The two-stroke internal combustion engine of claim 94, wherein said intake system supplies a stream of air comprising substantially all air flow through said intake system to said transfer passage.

101. The two-stroke internal combustion engine of claim 100, further comprising a diaphragm pump supplying fuel to said fuel injector, said diaphragm pump pumping the fuel in response to changes in pressure in said crankcase, a pressure regulator limiting a pressure of fuel supplied to said fuel injector, and wherein said fuel injector comprises an electro-magnetic coil adapted to open and close communication between a fuel inlet to said fuel injector and an outlet of said fuel injector, said electro-magnetic coil being responsive to an electronic control unit, and a spring biasing a plunger to close communication between said fuel inlet and said outlet.
